(19) United States
(12) Patent Application Publication
(10) Pub. No.: US 2006/0072227 A1
(43) Pub. Date: Apr. 6, 2006

(54) Method and apparatus for magnetic transfer

(75) Inventors: Masashi Aoki, Odawara-shi (JP); Kazunori Komatsu, Odawara-shi (JP); Akihisa Kita, Odawara-shi (JP); Minoru Araki, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/241,974

(22) Filed: Oct. 4, 2005

(30) Foreign Application Priority Data
Oct. 4, 2004 (JP) 291176/2004
Dec. 20, 2004 (JP) 368230/2004

(51) Int. Cl. G11B 5/86

(52) U.S. Cl. 360/17

(57) ABSTRACT

A magnetic transfer method for performing magnetic transfer is provided wherein magnetic transfer is performed by conjoining and holding in surface-to-surface contact by a holder a transfer master medium, on which transfer data is borne, and a slave medium, to which the transfer data is transferred, and by applying a transfer magnetic field to the transfer master medium held in the holder by a magnet disposed facing to a recordable surface of the slave medium. The holder and the magnet are held movable relative to each other in the direction of the normal to the recordable surface of the slave medium. The distance between the holder and magnet as seen in the direction of the normal is adjusted when magnetic transfer is performed.

### BACKGROUND OF THE INVENTION

1. Field of the Invention

The present invention relates to a method and apparatus for magnetically transferring transfer data from a transfer master medium, on which the transfer data is borne, to a slave medium, to which the transfer data is transferred, by conjoining in surface-to-surface contact the transfer master medium and the slave medium, and applying a transfer magnetic field to the transfer master medium and the slave medium.

2. Description of the Related Art

There have been proposed magnetic transfer apparatuses wherein a transfer magnetic field is applied to a transfer master medium having a topographic pattern, which has been formed corresponding to transfer data such as a servo signal and covered with a soft magnetic layer, and a slave medium having a magnetic recording layer, with the transfer master medium and the slave medium being conjoined in surface-to-surface contact, whereby the magnetic pattern corresponding to the transfer data borne on the transfer master medium is transferred and recorded on the slave medium.

Such magnetic transfer apparatuses include those comprising, as shown in FIG. 7, a holder member 362 which is constituted by an upper cylindrical pressing chamber 362a and a lower cylindrical base chamber 362b and serves to conjoin a slave medium and transfer master mediums in surface-to-surface contact with the center positions thereof being aligned to each other and hold the resulting conjoined body; and a ring-shaped electromagnetic heads 361 constituted by a core having a gap extending in a slave medium's radial direction from the center position of the slave medium and a wire wound around the core, wherein a transfer magnetic field generated at the gap of the ring-shaped electromagnetic head is applied to the slave medium and the transfer master mediums while rotating the holder member 362 in the direction of arrow such that these mediums are entirely exposed to the transfer magnetic fields (see, for example, U.S. Pat. No. 6,940,668).

On the other hand, a recent trend has been towards reducing the size of magnetic disks as a slave medium. While 3.5 inch magnetic disks and 2.5 inch magnetic disks have been commonly used, lately, magnetic disks not larger than 1 inch are becoming used. Accordingly, a need has arisen to perform magnetic transfer to the slave mediums of such size.

The slave mediums such as magnetic disks are provided with a non-recordable region located at a central portion or a radially innermost portion thereof and a recordable region which extends around the non-recordable region and is to be subjected to magnetic transfer. Therefore, a magnetic field distribution produced by a ring-shaped electromagnetic head is controlled such that a sufficiently strong magnetic field is applied to the aforementioned recordable region. At the central portion of the slave medium, however, an unnecessary leakage magnetic field is applied to a portion on a side of the center of the slave medium opposite to the position being subjected to the magnetic field. When the intensity of the leakage magnetic field becomes larger than a predetermined threshold value, a magnetic field in a direction opposite to the intended magnetic field to be applied is applied to the slave medium, which causes degradation of a transfer signal. This should be taken into account when the magnetic field distribution is controlled.

FIG. 6 shows an example of a magnetic distribution applied to a slave medium. The origin (0) in FIG. 6 indicates the center of a slave medium. The distance from the center of the slave manual is plotted on the horizontal axis and the intensity of the magnetic field is plotted on the vertical axis. For example, when the size of the non-recordable region is within a range b shown in FIG. 6, it is necessary to control such that a magnetic field distribution as shown in a graph G1 of FIG. 6 is produced. Further, in FIG. 6, a magnetic field intensity th1 is that required for performing magnetic transfer, and a magnetic field intensity th2 is that acceptable as intensity of a leakage magnetic field.

For magnetic disks (hard disks) increasingly used in hard disk drives, it is usual that, after delivery by a magnetic disk manufacturer to a drive manufacturer, format data (transfer data) and address data (transfer data) are written thereon before loaded within a hard disk drive. Such writing may be carried out using a magnetic head. However, it is effective and preferable to use a master disk (transfer master medium) on which data such as the format data and the address data have been written and transfer the data en bloc.

Conventionally, various proposals have been made for the magnetic transfer technology of this type (see, for example, U.S. Pat. No. 6,785,070). U.S. Pat. No. 6,785,070 proposes that when magnetic transfer is performed with a slave disk (slave medium) and master disks (transfer master mediums) being conjoined in surface-to-surface contact, the magnetic transfer is carried out while rotating a magnetic field generating device (magnet) and the conjoined body with respect to each other and changing a vertical distance between the magnetic field generating device and the conjoined body, whereby deterioration of reproduction signals is prevented.

However, as mentioned above, slave mediums as small as 1 inch or less have been brought into use in recent years. Generally, the smaller the radius of the slave medium, the smaller the range of its non-recordable region is. Therefore, when a magnetic field distribution G1 is applied to a slave medium having a non-recordable region within a range a shown in FIG. 6, the recordable region is partly exposed to the magnetic field intensity not larger than th1 and is partly exposed to the leakage magnetic field not smaller than th2.

The magnetic field distribution can be controlled by adjusting a distance between a holder member 362 and a ring-shaped electromagnetic head 361 in the direction of the normal to a recordable surface of the slave medium and a distance between a holder member 362 and the ring-shaped electromagnetic heads 361 in the radial direction of the slave medium. In the conventional magnetic transfer apparatuses, these distances are fixedly determined in advance and cannot be changed for structural reasons of such apparatuses, and therefore the magnetic field distribution cannot be changed depending on the range of the non-recordable region of the slave medium.

In addition, when magnetic transfer is carried out using the magnetic transfer apparatuses as mentioned above, the magnetic distribution should be adjusted such that a horizontal magnetic field is applied into the vicinity of a recordable surface of a target slave medium. In order to apply the horizontal magnetic field as mentioned above, it is necessary to adjust a spacing between an N-pole (north pole) portion and an S-pole (south pole) portion of the ring-shaped electromagnetic head 361 according to the distance between the holder member 362 and the ring-shaped electromagnetic head 361.

In the conventional magnetic transfer apparatuses, however, such a ring-shaped electromagnetic head 361 as described above is used and therefore the spacing between the N-pole portion and the S-pole portion is fixed and unchangeable. Because of this, for example, when magnetic transfer is performed to slave mediums which are different in thickness, a horizontal magnetic field cannot be applied in the same manner into the vicinity of each slave medium since the distance between the recordable surface of the slave medium and the ring-shaped electromagnetic head 361 differs from one slave medium to another.

Further, when magnetic transfer is performed to slave mediums which are different in magnetic coercive force Hcs, a magnetic field of intensity suitable for each slave medium cannot be applied without changing depending on the magnetic coercive force Hcs the distance between the holder member 362 and the ring-shaped electromagnetic head 361 in the aforementioned direction of the normal, and thus a suitable magnetic transfer cannot be achieved.

Further, when a magnetic transfer method as disclosed in U.S. Pat. No. 6,785,070 is used, the intensity ratio between the intensity of the magnetic field normal to a target disk surface and the intensity of the magnetic field horizontal to the disk surface spatially varies. Accordingly, this intensity ratio time-sequentially varies in association with a relative movement between a magnetic field generating device (magnet) and the disk. AS a result, there arises a problem that the Carrier-to-Noise ratio (C/N ratio) of a reproduction signal of a slave disk (slave medium) lowers.

### SUMMARY OF THE INVENTION

In view of the forgoing circumstances, it is an object of the invention to provide a magnetic transfer method and apparatus for performing magnetic transfer to various slave mediums which are different, for example, in size or in magnetic coercive force, wherein a suitable magnetic field can be applied for each slave medium.

Another object of the invention is to provide a magnetic transfer apparatus and method which is preferable for enhancing reliability in transferring a magnetic data pattern (transfer data) and for ensuring the quality of the magnetically transferred data.

A first magnetic transfer method of the invention comprises the steps of: by a holder member (holder), conjoining in surface-to-surface contact a transfer master medium, on which transfer data is borne, and a slave medium, to which the transfer data is transferred, to form a conjoined body, and holding the conjoined body; and by a magnetic field applying member (magnet) disposed facing to a recordable surface of the slave medium, applying a transfer magnetic field to the transfer master medium held in the holder member, wherein the holder member and the magnetic field applying member are held movable relative to each other in the direction of the normal to a recordable surface of the slave medium and a distance between the holder member and the magnetic field applying member as seen in the direction of the normal is adjusted when magnetic transfer is performed.

In the first magnetic transfer method, the adjustment may be performed such that a distance between the holder member and the magnetic field applying member as seen in the direction of the normal is made shorter when a size of a non-recordable region of the slave medium located at a central portion thereof is smaller.

Further, intensity of the transfer magnetic field may be adjusted according to a distance of the relative movement in the direction of the normal when magnetic transfer is performed.

Further, it is possible that the holder member and the magnetic field applying member is held movable relative to each other in a radial direction of the slave medium, and a position of the magnetic field applying member with respect to the holder member as seen in the radial direction is adjusted, when magnetic transfer is performed.

Further, the adjustment may be performed such that the magnetic field applying member is positioned closer to the center of the holder member when a size of a non-recordable region of the slave medium located at a central portion thereof is smaller.

Further, it is possible that the magnetic field applying member has an N-pole portion and an S-pole portion for producing a transfer magnetic field, the N-pole portion and the S-pole portion being situated close to each other, a spacing between the N-pole portion and the S-pole portion being adjustable; and the spacing between the N-pole portion and the S-pole portion is adjusted when magnetic transfer is performed.

Further, the adjustment may be performed such that the spacing between the N-pole portion and the S-pole portion is made smaller when a distance between the holder member and the magnetic field applying member as seen in the direction of the normal is shorter.

A second magnetic transfer method of the invention comprises the steps of: by a holder member, conjoining in surface-to-surface contact a transfer master medium, on which transfer data is borne, and a slave medium, to which the transfer data is transferred, to form a conjoined body, and holding the conjoined body; and by a magnetic field applying member disposed facing to a recordable surface of the slave medium, applying a transfer magnetic field to the transfer master medium held in the holder member, wherein the holder member and the magnetic field applying member are held movable relative to each other in a radial direction of the slave medium, and a position of the magnetic field applying member with respect to the holder member as seen in the radial direction is adjusted when magnetic transfer is performed.

Further, in the second magnetic transfer method, the adjustment may be performed such that the magnetic field applying member is positioned closer to the center of the holder member when a size of a non-recordable region of the slave medium located at a central portion thereof is smaller.

A third magnetic transfer method of the invention comprises the steps of: by a holder member, conjoining in surface-to-surface contact a transfer master medium, on which transfer data is borne, and a slave medium, to which the transfer data is transferred, to form a conjoined body, and holding the conjoined body; and by a magnetic field applying member disposed facing to a recordable surface of the slave medium, applying a transfer magnetic field to the transfer master medium held in the holder member, wherein the magnetic field applying member has an N-pole portion and an S-pole portion for producing a transfer magnetic field, the N-pole portion and the S-pole portion being situated close to each other, a spacing between the N-pole portion and the S-pole portion being adjustable; and the spacing between the N-pole portion and the S-pole portion is adjusted when magnetic transfer is performed.

In the third magnetic transfer method, the adjustment may be performed such that the spacing between the N-pole portion and the S-pole portion is made smaller when a distance between the holder member and the magnetic field applying member as seen in a direction of the normal to a recordable surface of the slave medium is shorter.

A first magnetic transfer apparatus of the invention comprises a holder member for conjoining in surface-to-surface contact a magnetic transfer master medium, on which transfer data is borne, and a slave medium, to which the transfer data is transferred, to form a conjoined body, and holding the conjoined body; and a magnetic field applying member, disposed facing to a recordable surface of the slave medium, for applying a transfer magnetic field to the transfer master medium held in the holder, and the magnetic transfer apparatus further comprises a normal-direction drive mechanism for holding the holder member and the magnetic field applying member so as to be movable relative to each other in a direction of the normal to a recordable surface of the slave medium such that a distance between the holder member and the magnetic field applying member as seen in the direction of the normal can be adjusted.

The first magnetic transfer apparatus may further comprise a normal-direction movement control device for controlling the normal-direction drive mechanism such that a distance between the holder member and the magnetic field applying member in the direction of the normal is made shorter when a size of a non-recordable region of the slave medium located at a central portion thereof is smaller.

In addition, the magnetic transfer apparatus may further comprise a magnetic field intensity adjusting device which can adjust intensity of the transfer magnetic field according to a relative movement distance in the direction of the normal.

In addition, the magnetic transfer apparatus may further comprise a radial-direction drive mechanism for holding the holder member and the magnetic field applying member so as to be movable relative to each other in a radial direction of the slave medium, such that a position of the magnetic field applying member with respect to the holder member as seen in the radial direction can be adjusted.

In addition, the magnetic transfer apparatus may further comprise a radial-direction movement control device (for example, a control circuit) for controlling the radial-direction drive mechanism such that the magnetic field applying member is positioned closer to the center of the holder member when a size of a non-recordable region of the slave medium located at a central portion thereof is smaller.

Further, it is possible that the magnetic field applying member has an N-pole portion and an S-pole portion for producing a transfer magnetic field, the N-pole portion and the S-pole portion are situated close to each other, and a spacing between the N-pole portion and the S-pole portion are adjustable.

In addition, the magnetic transfer apparatus may further comprise a spacing control device for controlling the magnetic field applying member such that the spacing between the N-pole portion and the S-pole portion is made smaller when a distance between the holder member and the magnetic field applying member as seen in the direction of the normal is shorter.

A second magnetic transfer apparatus of the invention comprises: a holder member for conjoining in surface-to-surface contact a magnetic transfer master medium, on which transfer data is borne, and a slave medium, to which the transfer data is transferred, to form a conjoined body, and holding the conjoined body; and a magnetic field applying member, disposed facing to a recordable surface of the slave medium, for applying a transfer magnetic field to the transfer master medium held in the holder, and the magnetic transfer apparatus further comprises a radial-direction drive mechanism for holding the holder member and the magnetic field applying member so as to be movable relative to each other in a radial direction of the slave medium, such that a position of the magnetic field applying member with respect to the holder member as seen in the radial direction can be adjusted.

In addition, the second magnetic transfer apparatus may further comprise a radial-direction movement control device for controlling the radial-direction drive mechanism such that the magnetic field applying member is positioned closer to the center of the holder member when a size of a non-recordable region of the slave medium located at a central portion thereof is smaller.

A third magnetic transfer apparatus of the invention comprises a holder member in which a transfer master medium, on which transfer data is borne, and a slave medium, to which the transfer data is transferred, are conjoined and held in surface-to-surface contact; and a magnetic field applying means, disposed facing to a recordable surface of the slave medium, for applying a transfer magnetic field to the transfer master medium held in the holder member, wherein the magnetic field applying member has an N-pole portion and an S-pole portion for producing a transfer magnetic field, the N-pole portion and the S-pole portion are situated close to each other, and a spacing between the N-pole portion and the S-pole portion are adjustable.

In addition, the third magnetic transfer apparatus may further comprise a spacing control device for controlling the magnetic field applying member such that the spacing between the N-pole portion and the S-pole portion is made smaller when a distance between the holder member and the magnetic field applying member as seen in the direction of the normal to the slave medium is shorter.

Further, according to the invention, there is provided a magnetic recording medium manufacturing process wherein magnetic recording mediums are manufactured by performing magnetic transfer to slave mediums by the use of any of the above-described first, second, and third magnetic transfer methods.

As used herein, “conjoined in surface-to-surface contact” indicates either a conjoined state in which surfaces are in direct contact with each other, or a state in which the surfaces are facing one another with a slight clearance being remaining therebetween.

Further, as used herein, “disposed facing to a recordable surface of the slave medium” includes not only the case of “disposed facing to the front side of the recordable surface of the slave medium”, but also the case of “disposed facing to the back side of the recordable surface of the slave medium” and the case of “disposed facing to the front and back sides of the recordable surface of the slave medium”.

Furthermore, as used herein, “a size of a non-recordable region of the slave medium located at a central portion thereof” indicates a region which is located at the central portion of the slave medium and to which any transfer data is not magnetically transferred (for example, a region, at the central portion of the slave medium, in which a hole is formed).

To achieve the foregoing objects, the present invention provides a magnetic transfer method comprising: a conjoining step for conjoining a pair of master disks (transfer master mediums), each of which has a surface where a magnetic pattern is formed, and a slave disk (slave medium), such that each patterned surface of the master disks contacts with each surface of the slave disk; a transfer preparation step in which a pair of magnetic field generating devices (magnets) are disposed at initial positions respectively located at a substantially equal distance, as seen in a direction of thickness of the transfer master mediums, from the back sides of the pair of the master disks; and a magnetic transfer step in which the distance between the conjoined body (the pair of master disks and the slave disk which have been conjoined together) and the pair of magnetic field generating devices is increased or decreased while giving a relative rotation movement between the conjoined body and the pair of the magnetic field generating devices, and magnetic fields are applied in a circumferential direction of these disks by the pair of the magnetic field generating devices, whereby the magnetic patterns of the master disks are transferred to the slave disk.

The present invention provides another magnetic transfer method comprising: a conjoining step for conjoining a pair of master disks, each of which has a surface where a magnetic pattern is formed, and a slave disk, such that each patterned surface contacts with each surface of the slave disk; a transfer preparation step in which a pair of magnetic field generating devices are disposed at initial positions respectively located at a substantially equal distance T, as seen in a direction of thickness of the transfer master mediums, from the back sides of the pair of the master disks; and a magnetic transfer step in which the distance T between the conjoined body (the pair of master disks and the slave disk which have been conjoined together) and the pair of magnetic field generating devices is increased or decreased while giving a relative rotation movement between the conjoined body and the pair of the magnetic field generating devices, and magnetic fields are applied in a circumferential direction of these disks by the pair of the magnetic field generating devices, whereby the magnetic patterns of the master disks are transferred to the slave disk.

For this end, the present invention also provides a magnetic transfer apparatus comprising: a disk holding device having a pair of holder elements for holding a pair of master disks, each of which has a surface where a magnetic pattern is formed; a conjoining device for conjoining a slave disk provided between the pair of the master disks by pressing the pair of the master disks such that the pair of the master disks are brought into contact with surfaces of the slave medium; and a magnetic transfer mechanism for transferring the magnetic patterns of the master disks to the slave disk wherein the predetermined distance T is increased or decreased by a linear drive mechanism while giving a relative rotation movement, by a rotary drive mechanism, between the disk holding device and the pair of magnetic field generating devices, which have been disposed at positions respectively located at a substantially equal distance T from the back sides of the pair of the master disks, and magnetic fields are applied in a circumferential direction of these disks by the pair of the magnetic field generating devices, whereby the magnetic patterns of the master disks are transferred to the slave disk.

According to the invention, the distance between a conjoined body, formed of the pair of master disks and the slave disk which have been conjoined together, and a pair of magnetic field generating devices is increased or decreased when a relative rotation movement is being given between the conjoined body and the pair of the magnetic field generating devices, and a magnetic field is applied in a circumferential direction of these disks by the magnetic field generating devices, whereby magnetic patterns of the master disks are transferred to the slave disk.

That is, since the magnetic fields are respectively applied to both sides of the conjoined body, magnetic fields perpendicular to the disk surfaces cancel one another out. As a result, only magnetic fields horizontal to the disk surfaces is applied to the conjoined body. This contributes to improve reliability in transferring a magnetic data pattern and ensure a quality of the slave disk after subjected to the magnetic transfer.

The relative rotation movement between the conjoined body and the pair of magnetic field generating devices may be performed, as described later, such that the conjoined body is fixedly locked and the magnetic field generating devices are rotated. Alternatively, the relative rotation movement may be performed such that the magnetic field generating devices are fixedly locked and the conjoined body is rotated.

In accordance with the prsent invention, it is preferable that the pair of magnetic field generating devices are positioned so as to be offset from a rotation axis of the relative rotational movement. While good magnetic transfer is ensured even if the magnetic field generating devices are located coaxially with the rotation axis, a horizontal magnetic field can be more effectively applied to a target disk surface when they are positioned offset from the rotation axis as described above.

Further, in accordance with the invention, it is also preferable that phases of the pair of magnetic field generating devices around the rotation axis are matched for the transfer preparation step, and phases of the pair of magnetic field generating devices around the rotation axis are matched once again for the relative rotation movement in the magnetic transfer step.

When phases of the pair of magnetic field generating devices around the rotation axis are matched as described above, the magnetic intensity patterns to be respectively applied to both sides of the slave disk can be made symmetric and a quality of the slave disk after subjected to the magnetic transfer can be further improved.

Further, in accordance with the invention, it is also preferable that the rotary drive mechanism rotates the pair of the magnetic field generating devices with the aid of one motor unit. When the pair of the magnetic field generating devices are rotated by a single motor unit as described above, matching the magnetic field generating devices in phase is facilitated. As a specific example, the rotary drive mechanism may be a combination of a pulley and a timing belt.

In accordance with the invention, it is also preferable that the linear drive mechanism comprises a pair of linear motors. Driving with linear motors would produce smooth travel of the magnetic field generating devices.

In accordance with the invention, it is also preferable that the linear drive mechanism comprises: a screw element having a single shaft provided with a normal-threaded portion and a reverse-threaded portion; a normal nut element that meshes with the normal-threaded portion; a reverse nut element that meshes with the reverse-threaded portion; and a single motor unit for rotating the screw element.

In this way, when a screw element provided with the normal-threaded portion and a reverse-threaded portion is used, a pair of the magnetic field generating devices can be driven simultaneously by rotating such a screw element. As a result, positioning accuracy is improved and the construction of the drive mechanism can be simplified.

Further, in accordance with the invention, it is preferable that a distance L1 between one surface of the slave disk and a distal end of one of the pair of magnetic field generating devices is matched with a distance L2 between another surface of the slave disk and a distal end of another one of the pair of magnetic field generating device in the transfer preparation step; and the distance L1 between one surface of the slave disk and a distal end of one of the pair of magnetic field generating devices is matched with the distance L2 between another surface of the slave disk and a distal end of another one of the pair of magnetic field generating device once again in the magnetic transfer step.

In this way, when not only the respective distances between a pair of master disks and a pair of magnetic field generating devices are matched, but also the respective distances between both surface of the slave disk and the pair of the magnetic field generating devices are matched, the magnetic intensity patterns to be respectively applied to both sides of the slave disk can be made symmetric and a quality of the slave disk after subjected to the magnetic transfer can be further improved.

With the magnetic transfer method and apparatus of the invention, a distance between the holder member (holder) and the magnetic field applying member (magnet) as seen in the direction of the aforementioned normal to a recordable surface of a target slave medium is made adjustable. Therefore, a magnetic field of sufficient intensity can be applied to various recordable regions of different-sized slave mediums having a non-recordable region. Further, a leakage magnetic field can be controlled not to exceed a predetermined threshold value, as a result of which an optimum magnetic field can be applied to each individual slave medium. More specifically, it is possible to control such that: when the size of the non-recordable region is within the range b shown in FIG. 6, a magnetic field distribution as shown in the graph G1 of FIG. 6 is produced; and when the size of the non-recordable region is within the range a shown in FIG. 6, a magnetic field distribution as shown in the graph G2 of FIG. 6 is produced. That is, the slope near the origin of a magnetic field distribution curve shown in FIG. 6 can be adapted to change depending on the size of the non-recordable region.

Further, when a distance between the holder member and the magnetic field applying member as seen in the direction of the normal is made shorter when the magnetic coercive force of the slave medium is smaller, a magnetic field of optimum intensity be applied to each individual slave medium even when magnetic transfer is performed to various slave mediums different in magnetic coercive force.

For example, in the case in which the distance between the holder member and the magnetic field applying member as seen in the direction of the normal to a recordable surface of a target slave medium is reduced, not only the slope near the origin of a magnetic field distribution curve increases, but also the intensity of the magnetic field in the recordable region unfavorably increases (as indicated by a broken line in FIG. 6). However, when the intensity of the magnetic field is made smaller when the distance is shorter, a magnetic field of optimum intensity can be applied to the recordable region, while avoiding application of a magnetic field of excessive intensity as mentioned above.

In addition, in the case in which the position of the magnetic field applying member with respect to the holder member as viewed in the radial direction of a target slave medium is adjusted, for example, when the adjustment is performed such that the magnetic field applying member is positioned closer to the center of the holder member when a size of a non-recordable region of the target slave medium located at a central portion thereof is smaller, an optimum magnetic field can be also applied to a portion of the recordable region in the vicinity the non-recordable region.

Further, in the case in a spacing between an N-pole portion and an S-pole portion of the magnetic field applying member is adjusted when magnetic transfer is performed, for example, when the adjustment is performed such that the spacing between the N-pole portion and the S-pole portion is made smaller, a horizontal magnetic field can always be applied to the vicinity of the recordable surface, for example, even when the distance between the holder member and the magnetic field applying member as seen in the direction of the normal to a recordable surface of a target slave medium can be adjusted according to the size of the non-recordable region as described above. Further, even in the case in which magnetic transfer is applied to various slave mediums different in thickness, when the adjustment is performed such that the spacing between the N-pole portion and the S-pole portion is made smaller when a distance between the holder member and the magnetic field applying member as seen in the direction of the normal to a recordable surface of a target slave medium is shorter, a horizontal magnetic field can always be applied to the vicinity of the recordable surface.

Further, the present invention would improve reliability in transferring a magnetic data pattern (transfer data) and ensure the quality of the magnetically transferred data.

### BRIEF DESCRIPTION OF THE DRAWINGS

FIG. 1 is a perspective view showing a schematic construction of a magnetic transfer apparatus according to one embodiment of the invention;

FIG. 2 is a sectional view of a holder member incorporated in the magnetic transfer apparatus shown in FIG. 1;

FIG. 3 shows the interior of the holder member shown in FIG. 2, as seen from above;

FIGS. 4A and 4B are views for illustrating operations of the magnetic transfer apparatus shown in FIG. 1;

FIGS. 5A and 5B are views for illustrating the effect of the magnetic transfer performed by the magnetic transfer apparatus shown in FIG. 1;

FIG. 6 is a view for illustrating operation of the magnetic transfer apparatus shown in FIG. 1;

FIG. 7 is a perspective view showing a schematic construction of a conventional magnetic transfer apparatus;

FIG. 8 is a partial cut-away view of the magnetic transfer apparatus according to the apparatus;

FIG. 9 is a perspective view showing how a slave disk is placed into and removed from a disk cassette;

FIG. 10 is a sectional view showing a construction of a holder unit;

FIG. 11 is a perspective view showing an aligned state of a master disk and a slave disk;

FIG. 12 is a sectional view showing a construction of a magnetic transfer mechanism;

FIGS. 13A and 13B respectively show front view and side view showing is a sectional view showing an arrangement of magnets;

FIG. 14 is a perspective view showing another construction of a magnetic transfer mechanism; and

FIG. 15 is a perspective view showing still another construction of a magnetic transfer mechanism.

### DESCRIPTION OF THE PREFERRED EMBODIMENTS

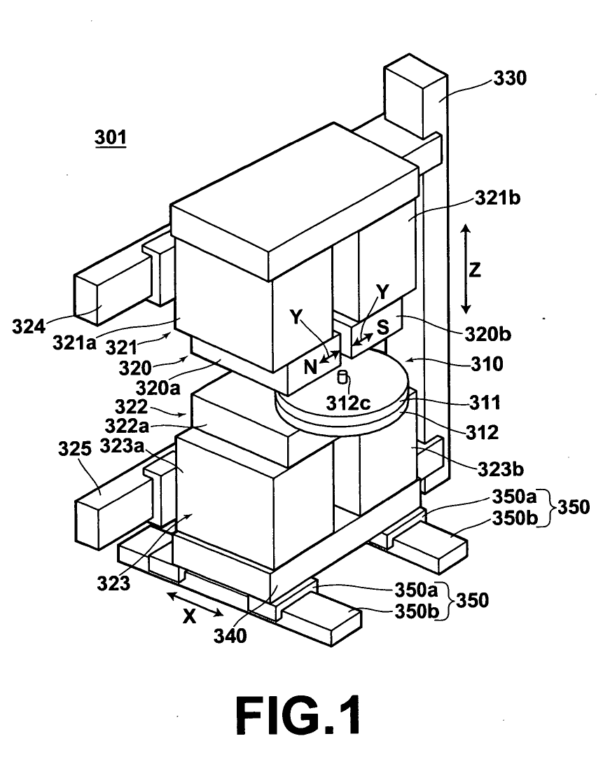

Hereinafter, an embodiment of a magnetic transfer apparatus for implementing a magnetic transfer method of the present invention will be described with reference to the drawings. FIG. 1 is a perspective view showing a schematic construction of a magnetic transfer apparatus according to the embodiment.

As shown in FIG. 1, the magnetic transfer apparatus 301 comprises: a holder member (holder) 310 in which a transfer master mediums each bearing thereon transfer data and a slave medium to which the transfer data is transferred are conjoined and held in surface-to-surface contact with each other; and a pair of magnetic field applying members (magnets) 320 and 322 for applying a transfer magnetic field to the transfer master mediums and the slave medium held in the holder member 310.

The magnetic field applying members 320 and 322 are oppositely disposed above and under the holder member 310 such that these members 320 and 322 face to recordable surfaces of the slave medium held in the holder member 310. The magnetic field applying members 320 and 322 are respectively provided with an N-pole portion 320a, 322a and an S-pole portion 320b, 322b (the S-pole portion 322b is not shown). The N-pole portion 320a, 322a and the S-pole portion 320b, 322b define a gap extending in the radial direction of the holder member 310 from the center position of the holder member 310. The N-pole portions 320a, 322a and the S-pole potions 320b, 322b are respectively provided electromagnets and create in the gap a transfer magnetic field which is parallel to the circumferential direction of the holder member 310. The direction of the transfer magnetic fields produced by the N-pole portion 320a and the S-pole portion 320b is same as that of the transfer magnetic fields produced by the N-pole portion 322a and the S-pole portion 322b. Rotating the holder member 310 allows the magnetic field applying members 320 and 322 to apply a transfer magnetic field across the slave medium and transfer master mediums which have been held in a conjoined manner in the holder. In this particular embodiment, the magnetic field applying members are disposed above and under the holder member 310. Alternatively, one magnetic field applying member may be provided only on one side. Further, instead of electromagnets, permanent magnets may be used for producing a transfer magnetic field similar to that described above.

An N-pole portion 320a and an S-pole portion 320b of a magnetic field applying member 320 are attached to a magnet drive mechanism 321. The magnet drive mechanism 321 comprises a north-pole-side drive mechanism 321a which supports the N-pole portion 320a so as to be movable in the direction indicated by arrow Y (the direction in which the magnetic field is produced) and a south-pole-side drive mechanism 321b which supports the S-pole portion 320b so as to be movable in the direction indicated by arrow Y. On the other hand, an N-pole portion 322a and an S-pole portion 322b which constitute a magnetic field applying member 322 are attached to a magnet drive mechanism 323. The magnet drive mechanism 323 comprises a north-pole-side drive mechanism 323a which supports the N-pole portion 322a so as to be movable in the direction indicated by arrow Y (the direction in which the magnetic field is produced) and a south-pole-side drive mechanism 323b which supports the S-pole portion 322b so as to be movable in the direction indicated by arrow Y. In this regard, any known construction may be employed for the drive mechanism.

The magnet drive mechanisms 321 and 323 are respectively secured to fixing members 324 and 325. The fixing members 324 and 325 to which the magnet drive mechanisms 321 and 323 are respectively secured are mounted to a column 330 to be movable in the direction indicated by arrow Z (i.e., the direction normal to the recordable surface of the slave medium held in the holder member 310). In this regard, any known construction may be employed for the for drive mechanism. The lower end of the column is secured to a mount 340.

The mount 340 is mounted to a pair of magnetic field applying device drive mechanisms 350. The magnetic field applying device drive mechanism 350 is constituted by a movable member 350a on which the mount 340 is attached and a rail member 350b on which the movable member 350a can be moved in the direction indicated by arrow X (i.e. the radial direction of the holder member 310). In this regard, any known construction may be employed for the for drive mechanism.

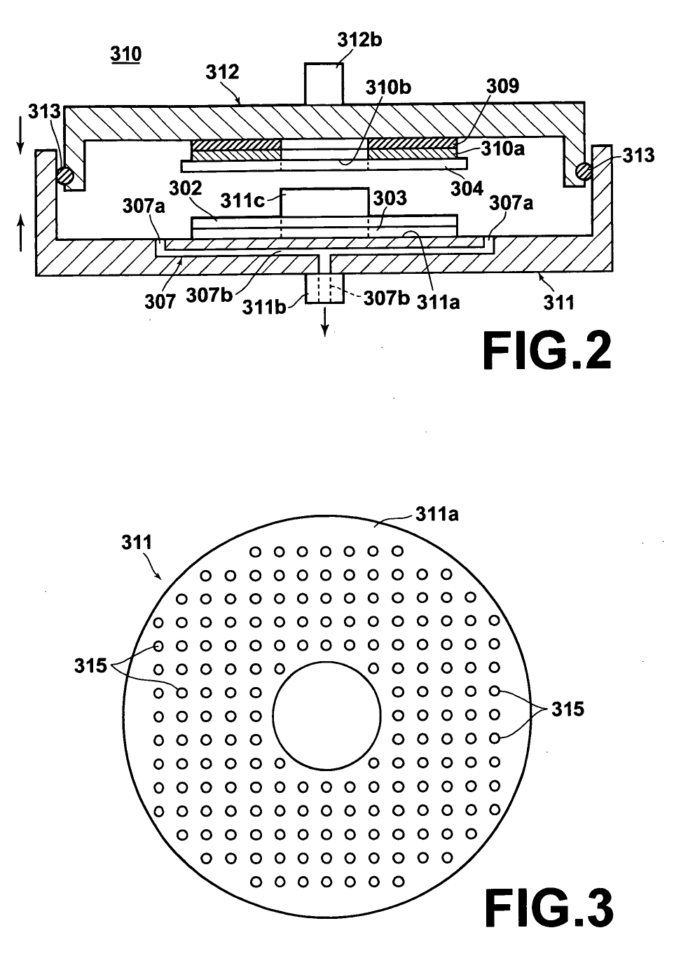

The holder member 310 is attached to a holder holding member (not shown) which rotatably holds the holder member 310. FIG. 2 shows a sectional view of the holder member, and FIG. 3 shows the interior of the holder member, as seen from above.

As shown in FIG. 2, the holder member 310 comprises a lower cylindrical base chamber 311 and an upper cylindrical pressing chamber 312. In an interior space 306 defined by the base chamber 311 and the pressing chamber 312, a slave medium 302 and transfer master mediums 303 and 304 are held conjoined in surface-to-surface contact with the center positions of the slave medium 302 and the transfer master mediums 303 and 304 being aligned to each other.

A pressure-reducing suction part 311a with a good flatness is provided at the central portion of the base chamber 311. As shown in FIG. 3, the pressure-reducing suction part 311a includes a lot of suction pores 315 which are connected to a vacuum suction pump. The pressure-reducing suction part 311a draws air through the suction pores 315, such that it holds by vacuum the back side of the master medium 303 in contact with the pressure-reducing suction part 311a and serves to correct the flatness of the master medium 303 along the pressure-reducing suction part 311a.

A sheet type annular elastic element 309 is attached to the inner surface of the pressing chamber 312, and a flat rigid plate 310a having a desired flatness is disposed on the elastic element 309. A pressure-reducing suction member 310b is provided at a central portion of the flat rigid plate 310a. The pressure-reducing suction part 310b holds by vacuum the upper surface of the transfer master medium 304 with the center positions thereof being aligned to each other. Similar to the pressure-reducing suction part 311b, the pressure-reducing suction part 310b is also provided with suction pores 315 connected to a vacuum suction pump. Thus, the transfer master medium 304 is held by suction through the suction pores 315.

Further, the pressing chamber 312 can be axially (vertically as viewed in the figure) moved towards and away from the base chamber 311. Accordingly, a center hole of the slave medium 302 is engaged with a center pin 311c vertically extending from the central portion of the base chamber 311, and the slave medium 302 is subjected to positioning. Rotational shafts 311b and 312b are provided so as to be protruding from the lower surface of the base chamber 311 and the upper surface of the pressing chamber 312. The base chamber 311 and the pressing chamber 312 are coordinated with a holder supporting member and rotated as one.

Then, a sealing element 313, which is an O-ring, is attached around the pressing chamber 312, and when the pressing chamber 312 is moved towards the base chamber 311, this sealing element 313 slidably contacts the inner circumference surface of the base chamber 311 and hermetically seals the interior space 6 defined within the both chambers 311 and 312.

An air expelling vent 307a is provided in the inner surface of the base chamber 311. An air channel 307b in communication with this air expelling vent 307a is formed within the base chamber 311, leads to the exterior through the rotational shafts 311b, and is connected to a vacuum suction pump (not shown). The pressure within the interior space 306 of the holder member 310 is controlled to a predetermined pressure by drawing the air within the interior space 306 of the holder member 310 through the air expelling vent 307a and the air channel 307b by the vacuum suction pump. As a result, the slave medium 302 and the transfer master medium 303 can be conjoined under a predetermined conjoining pressure. In this regard, it is desirable that the suction pressures of the pressure-reducing suction parts 311a and 310b are controlled such that a pressure within the interior space 306 is higher (and a vacuum level therein is lower) than the suction pressures of the pressure-reducing suction parts 311a and 310b.

The slave medium 302 is a disk-shaped magnetic recording medium such as a hard disk, a high-density flexible disk or the like, on which a magnetic recording layer has been formed on each side thereof. The magnetic recording layer consists of either a coated type magnetic recording layer, or a metallic thin film type magnetic recording layer. Further, a non-recordable region to which no transfer data can be magnetically transferred is provided at the central portion of the slave medium 302.

The transfer master medium 303, 304 comprises a circular substrate on which a fine topographic pattern corresponding to data to be transferred is provided; and a soft magnetic layer formed on the fine topographic pattern. The surface of the transfer master medium on which the fine topographic pattern is provided is brought into contact with the slave medium 302 and the other surface is held by suction by the base chamber 311 and the rigid plate 310a.

In this particular embodiment, the transfer master mediums 303 and 304 are conjoined on top of and beneath the horizontally oriented slave medium 302, and a double sided concurrent magnetic transfer is performed to the conjoined body. However, it is also possible that the slave medium 302 and the transfer master mediums 303 and 304 are vertically oriented and the double sided concurrent magnetic transfer is performed thereto. Further, it is also possible that the transfer master medium 303 or 304 is conjoined to one surface of the slave medium 302 and the single sided successive magnetic transfer is performed to the conjoined body.

Hereinafter, a magnetic transfer process will be described. In the case of the aforementioned magnetic transfer apparatus 301, the transfer master medium 303 is properly aligned and held in place with respect to the pressure-reducing suction parts 311a of the base chamber 311, and the transfer master medium 304 is properly aligned and held in place with respect to the pressure-reducing suction part 310b of the rigid plate 310 of the pressing chamber 312. Then, the slave medium 302 is set such that the center position thereof is properly aligned in place when the pressing chamber 312 and the base chamber 311 are in the open state where they are spaced apart from one another. Thereafter, the pressing chamber 312 is moved towards the base chamber 311.

At this time, the sealing element 313 of the pressing chamber 312 slidably contacts the inner circumference surface of the base chamber 311, whereby the interior space 306 of the holder member 310 in which the slave medium 302 and the transfer master mediums 303 and 304 are accommodated is hermetically sealed. Before the transfer master medium 304 and the slave medium 302 come into contact with each other and undergo pressure, the vacuum suction pump expels air from the interior space 306 to reduce the pressure therein, such that a predetermined pressure greater than the suction pressures by the pressure-reducing suction parts 311a and 310b is provided within the interior space 306. Then, the pressing chamber 312 is further downwardly moved, air between the slave medium 302 and each transfer master mediums 303, 304 is withdrawn, and the slave medium 302 and the transfer master mediums 303 and 304 are conjoined in surface-to-surface contact under a predetermined conjoining pressure.

After the transfer master medium 303 and 304 and the slave medium 302 are loaded in the holder member 310 as described above, according to the size of the non-recordable region of the loaded slave medium 302, the magnetic field applying members 320 and 322 are moved in the X-direction by the magnetic field applying device drive mechanisms 350. This X-direction movement is carried out such that the magnetic field applying members 320 and 322 are positioned closer to the center of the holder member 310 when the size of the non-recordable region is smaller. The movement amount of this time may be adjusted, for example, such that a magnetic field of intensity necessary for magnetic transfer is also applied to a portion of the recordable region in the vicinity of the boundary between the non-recordable region and the recordable region of the slave medium 302.

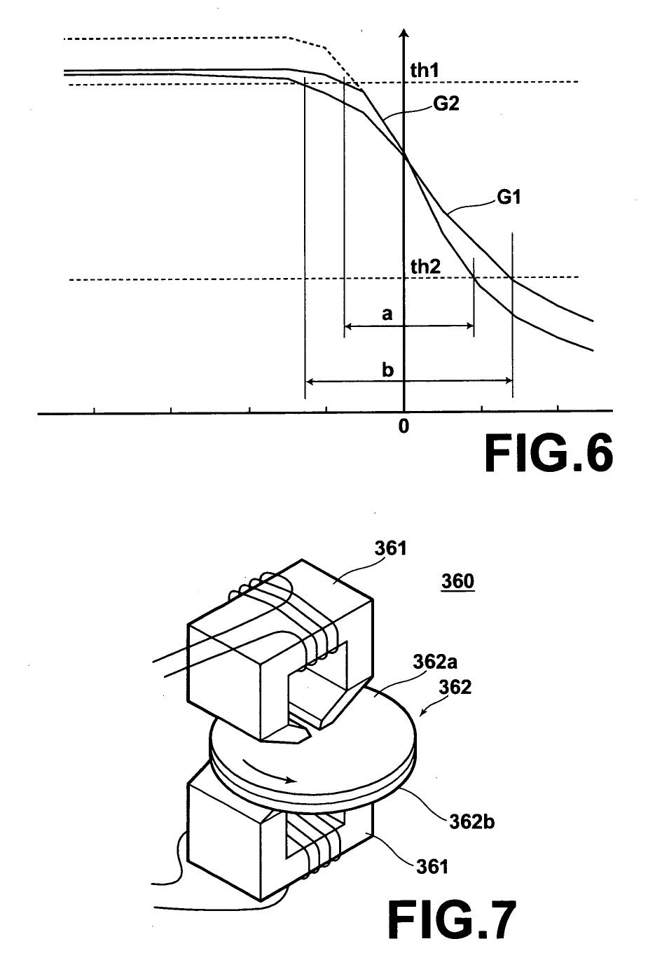

Further, the magnetic field applying members 320 and 322 are also moved in the Z-direction together with the fixing members 324 and 325 according to the size of the non-recordable region of the loaded slave medium 302. In addition, the magnetic field applying members 320 and 322 are moved in opposite directions to one another through the same distance. In other words, in this particular embodiment, when one magnetic field applying member 320 is moved downward, the other magnetic field applying member 322 is moved upward, whereas one magnetic field applying member 320 is moved upward, the other magnetic field applying member 322 is moved downward. At this time, the magnetic field applying members 320 and 322 are moved such that the distance in Z-direction (hereinafter referred to as “Z-direction distance”) between the holder member 310 and the magnetic field applying members 320 and 322 becomes shorter when the size of the non-recordable region is smaller. The movement amount of this time may be adjusted, for example, such that a magnetic field of sufficient intensity is applied to the recordable region of the slave medium 302 is applied and the aforementioned leakage magnetic field does not exceed a predetermined threshold value. More specifically, it is only necessary to control such that: when the size of the non-recordable region is within the range b shown in FIG. 6, a magnetic field distribution as shown in the graph G1 of FIG. 6 is produced; and when the size of the non-recordable region is within the range a shown in FIG. 6, a magnetic field distribution as shown in the graph G2 of FIG. 6 is produced.

In the particular embodiment, the Z-direction distance between the holder member 310 and the magnetic field applying member 320, 322 is adjusted according to the size of the non-recordable region of the slave medium 302. Alternatively, the Z-direction distance between the holder member 310 and the magnetic field applying member 320, 322 may be adjusted to be shorter when the magnetic coercive force of the slave medium 302 is smaller.

In addition to moving the magnetic field applying members 320 and 322 in Z-direction as described above, the intensity of the transfer magnetic field generated at each magnetic field applying member 320, 322 may also be adjusted according to the Z-direction distance between the holder member 310 and each magnetic field applying member 320, 322. In such a case, when an electromagnet is used as the magnetic field applying member 320, 322, for example, a magnetic field intensity adjusting device (not shown) may be provided for controlling a current flowing through the electromagnet. In this regard, the current may be manually or automatically adjusted. When automatic current adjustment is employed, this adjustment may comprise: preloading in the magnetic field intensity adjusting device a table for correlating information indicating the Z-direction distance between the holder 310 and the magnetic field applying member 320, 322 and a current value to flow through an electromagnet; obtaining actual information indicating the Z-direction distance by detection with a sensor or the like; determining a correlated current value based on the obtained distance information by looking up the table; and supplying the current of the so-determined current value. Further, when a permanent magnet is used as the magnetic field applying member 320, 322, the intensity of the transfer magnetic field may be adjusted by replacement of the permanent magnet. Furthermore, the intensity of the transfer magnetic field is only necessary to be adjusted such that a magnetic field having intensity, which as low as a threshold intensity necessary for magnetic transfer, is applied to the recordable region of a slave medium. For example, a intensity in the range of 0.6-1.3 times the coercive magnetic force Hc of the slave medium is desirable.

More specifically, when the Z-direction distance between the holder member 310 and the magnetic field applying member 320, 322 is set shorter as described above, for example, the magnetic field intensity in the recordable region may become as high as indicated by a broken line of FIG. 6. In such a case, when the magnetic field intensity is adjusted as described above, a magnetic field of optimum intensity can be applied to the recordable region, while avoiding application of a magnetic field of excessive intensity as mentioned above.

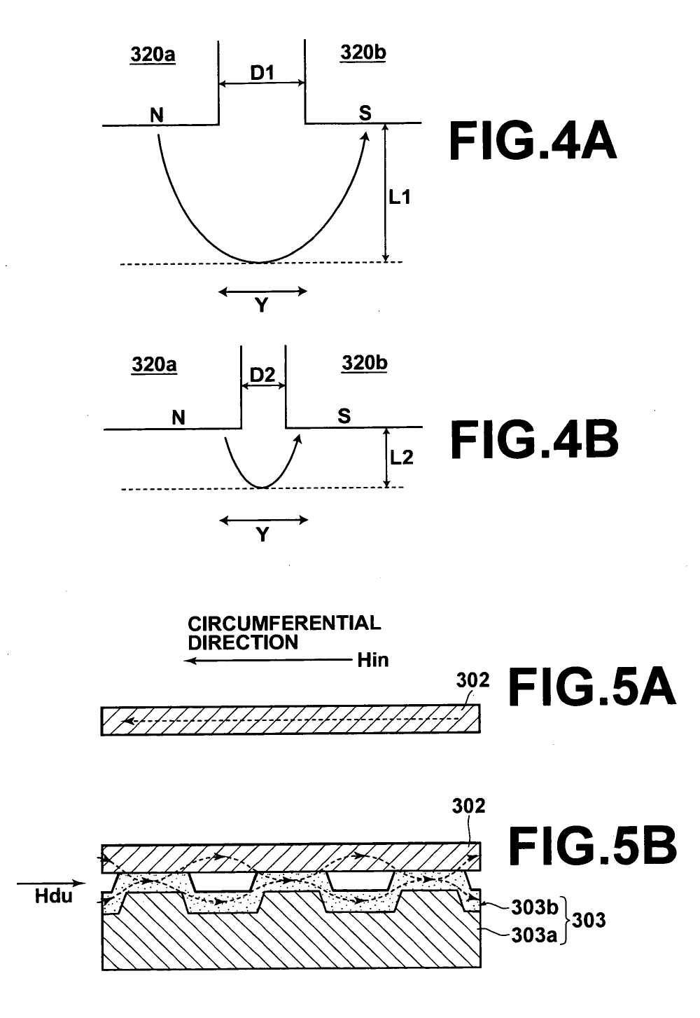

Besides, the N-pole portion 320a and the S-pole portion 320b of the magnetic field applying member (magnet) 320 are moved in the direction indicated by arrow Y by the magnet drive mechanisms 321, while the N-pole portion 322a and the S-pole portion 322b of the magnetic field applying member 322 are moved in the direction indicated by arrow Y by the magnet drive mechanisms 323. The N-pole portion 320a, 322a and the S-pole portion 320b, 322b are adjusted to be less spaced when the Z-direction distance between the holder member 310 and the magnetic field applying member 320, 322 is shorter. By virtue of the adjustments as described above, a horizontal magnetic field can always be produced in the vicinity of the recordable surface (indicated by the dashed lines in FIGS. 4A and 4B) of a target slave medium 302 as shown in FIGS. 4A and 4B. In FIGS. 4A and 4B, there is the relationship given by: D2<D1 and L2<L1.

In the particular embodiment, the Z-direction distance between the holder member 310 and the magnetic field applying member 320, 322 is adjusted according to the size of the non-recordable region of the slave medium 302, and the spacing between the N-pole portion 320a, 322a and the S-pole portion 320b, 322b is adjusted according to the adjusted distance. However, the present invention not limited thereto. For example, in the case where magnetic transfer is performed to slave mediums 302 which are different in thickness, the N-pole portion 320a, 322a and the S-pole portion 320b, 322b may be adjusted to be less spaced when the Z-direction distance between the holder member 310 and the magnetic field applying member 320, 322 is shorter.

In this regard, movements in X-axis, Y-axis, and Z-axis directions as described above may be manually or automatically performed. When these movements are performed automatically, what is necessary is, for example, to preload a table for correlating a size of a non-recordable region of a slave medium 302 to the aforementioned X-direction, Y-direction, and Z-direction movement amounts, in a controller (not shown) for controlling a magnetic field applying device drive mechanisms 350, a fixing member 324, and magnet moving mechanisms 321 and 323; obtain the size of the non-recordable of the slave medium 302 by automatic detection with a sensor, barcode, and the like or by data entry by a user with an input device; determine a movement amount suitable for the size of the so-obtained non-recordable region of the slave medium 302 by looking up the table; and carry out the X-direction movement, the Y-direction movement, and the Z-direction movement according to the determined move amounts. Further, since it is known that a size of a slave medium and a size of its non-recordable region are in proportion to each other, these movement amounts may be determined based on the size of a slave medium 302, rather that the size of a non-recordable region thereof.

In the particular embodiment, movements in three directions (X-direction, Y-direction, and Z-direction) are performed. However, movement in at least one direction of the three may be performed. Further, it is also possible to automatically perform movement in one or two directions of the three, and manually perform the remaining movement (or movements).

After completion of the X-direction, Y-direction, and Z-direction movements, the transfer magnetic field is applied across the transfer master mediums 303 and 304 by applying the transfer magnetic field by the transfer magnetic field applying members 320 and 322 while rotating the holder member 310, whereby the magnetic pattern corresponding to the transfer pattern formed on the transfer master medium 303, 304 is transferred and recorded onto the magnetic recording layer of the slave medium 302.

In the particular embodiment, as the transfer master mediums 303 and 304, those comprising a substrate 33a which is made of metal or the like and provided with a fine topographic pattern corresponding to transfer data as shown in FIG. 5B; and a magnetic layer 303b layered on the fine topographic pattern along the surface profile thereof are used.

For manufacturing magnetic recording mediums, first, as shown in FIG. 5A, a magnetic field Hᵢₙ is previously applied to the slave medium 302 in its circumferential direction (track direction), whereby the magnetic recording layer is subjected to initial magnetization. Thereafter, as shown in FIG. 5B, the slave medium 302 is conjoined in surface-to-surface contact with the transfer master medium 303 and a transfer magnetic field H_{du} is applied in the direction opposite the initializing magnetization direction. At this time, the transfer magnetic field H_{du} is selectively absorbed only in a prominence pattern in the soft magnetic layer 303b of the transfer master medium 303 which is in contact with the slave medium 302. As a result, the initial magnetization of the portion which is in contact with the prominence pattern is not inverted, whereas the initial magnetization of the other portions is inverted, and the transfer pattern formed on the master medium 303 is transferred to the slave medium 302. While the description is given on the magnetic transfer with one transfer master medium 303, the magnetic transfer with the other transfer master medium 304 is performed in the same manner.

After completion of the magnetic transfer as described above, suctioning by the vacuum suction pump is stopped, the interior space 306 is opened to the ambient atmosphere and the pressing chamber 312 is moved away from the base chamber 311, whereby the conjoining force is released. The slave medium 302 is removed from the holder member 310 and forwarded to the following process step. Then, a new slave medium 302 is loaded in the holder member 310, and the magnetic transfer process is repeated in the same manner.

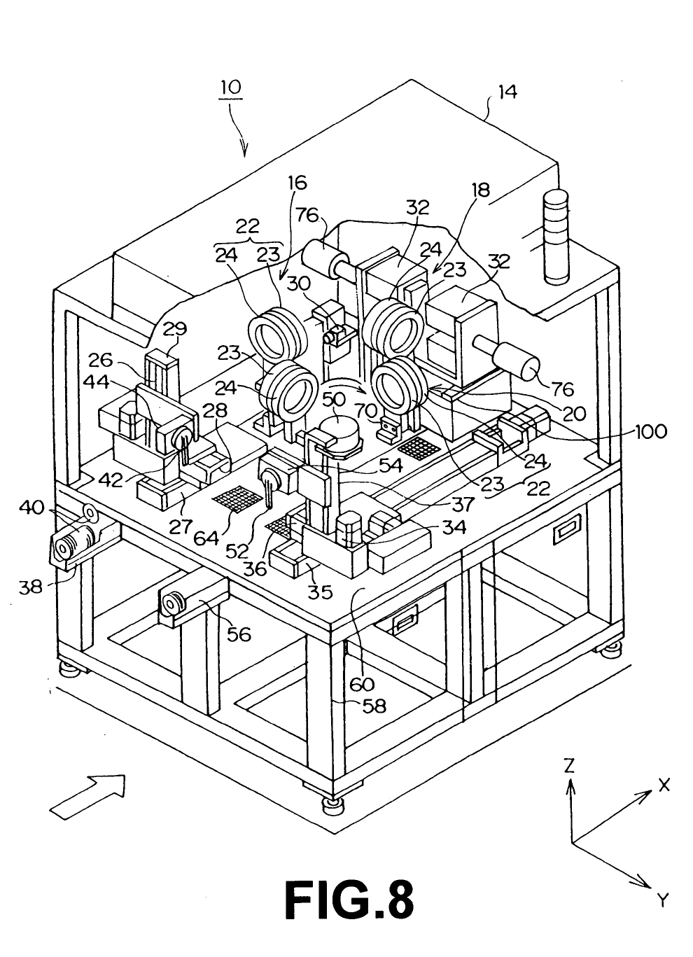

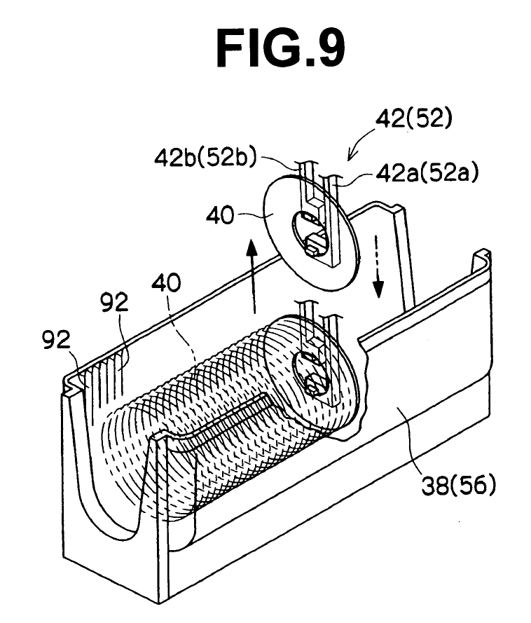

Hereinafter, a transfer apparatus and method according to another preferable embodiment of the invention will be described in detail in connection with the drawings. FIG. 8 is a perspective view showing a general configuration of a magnetic transfer apparatus 10 which is a transfer apparatus according to the invention, and FIG. 9 is a schematic perspective view of a disk cassette. The magnetic transfer apparatus 10 is constituted by a main body 12 and a cleaning unit 14.

The main body 12 comprises a frame 58 on which a base 60 which defines a horizontal plane is provided. The side indicated by a thick arrow is a front side of the main body 12. The cleaning unit 14 is disposed circumferentially around the periphery of the main body 12 so that the cleanliness of the main body is ensured.

A clean air blowing unit for supplying clean air to the interior of the apparatus is provided on a ceiling of the cleaning unit 14. The clean air blowing unit, which is constituted by an air filter (for example, a HEPA filter (high efficiency particulate air filter) or an ULPA filter (ultra low penetration air filter)) and a blower fan, can deliver clean downflow air less than cleanliness class 100 to the interior of the apparatus.

The clean air blown from the clean air blowing unit is discharged to the atmosphere. Therefore, as shown in FIG. 8, a plurality of exhaust fans 64 as exhausting units are disposed at a space area in the base 60 within the main body 12 where any mechanisms are not disposed.

At the front end of the base 60, a disk supply cassette 38 for holding therein slave disks (slave mediums) 40 which are disks to be subjected to transfer and a disk carryout cassette 56 as a cassette for collecting the slave disks 40 which has been subjected to the magnetic data transfer and is carried out from the main body. The disk supply cassette 38 and the disk carryout cassette 56 have the same shape.

As shown in FIG. 9, the disk supply cassette 38 and the disk carryout cassette 56 can hold therein a plurality of the slave disks 40 in a surface-to-surface relationship. More specifically, a plurality of parallel grooves 92, 92 . . . are formed on the inner surface of the cassette. Each of the slave disks 40 can be loosely inserted into each of a plurality of grooves 92, 92. The peripheral edge of the slave disk 40 is supported by the surface of the groove 92, and the plurality of slave disks are spaced one another.

An index table 50 is rotatably mounted almost at the center of the top surface of the base by means of a shaft extending in the direction perpendicular to the base 60. Four holder units (holder) 22 as a holding means for holding a pair of master disks (transfer master medium) 46 and one slave disk 40 are mounted on the index table 50 such that they are respectively spaced equidistantly apart (at angles of 90°) in the rotational direction of the index table 50.

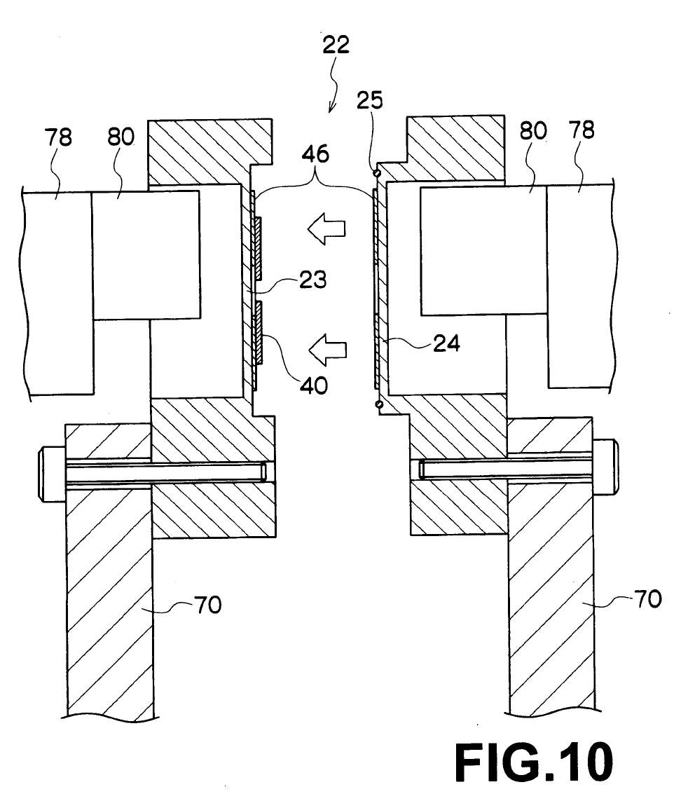

As shown in the cross-sectional view of FIG. 10, the holder unit 22 is constituted by a pair of holder elements: a stationary holder 23 and a movable holder 24. The stationary holder 23 and the movable holder 24 cooperate with each other to position, secure, and support the respective master disks 46 using vacuum adsorption, adhesion or the like by off-line setup, then hold by vacuum the slave disk 40, and hold these disks in close physical contact one another with the slave disk 40 being interposed between the master disks 46, 46.

In order to record magnetic information on respective main surfaces of the slave disk 40, the stationary holder 23 and the movable holder 24 respectively hold the master disks 46, 46 the data born on which are different to each other. In this way, the master disks 46, 46 in pair can sandwich the slave disk 40 so as to in contact with the respective surfaces of the slave disk 40.

The stationary holder 23 is a round cup-like member, and the master disk 46 can be secured in this cup. Meanwhile, the movable holder 24 is a disk-shaped member, and the master disk 46 can be secured on the surface. Further, the stationary holder 23 is secured to the main body 12 via a robot arm 70.

On the other hand, the movable holder 24 is secured to the main body 12 via a drive mechanism (not shown) by which the robot arm 70 is supported. Accordingly, the movable holder 24 can be moved towards and away from the stationary holder 23. Further, an O-ring 25 is affixed in the vicinity of the peripheral edge of the movable holder 24.

The region of each of the stationary holder 23 and movable holder 24 where the master disk 46 is attached is made thinner by removing the material from the back side (the side opposite the master disk), whereby the distance between the distal end of a magnet 80 (described later) and the back side of the master of the master disk 46 can be reduced. The magnet 80 is supported by a magnet holder 78 as described below.

In FIG. 10, the magnet 80 is shown in phantom line in the vicinity of the back side of the master disk 46. However, in practice, the magnet 80 is positioned in the vicinity of the back side of the master disk 46 only when the slave disk 40 is interposed between the master disks 46, 46 with the main surfaces of the slave disk 40 being in contact with the master disks (a position 18 where a magnetic transfer step shown in FIG. 8 is carried out). Before magnetic transfer is performed, the distance between the distal ends of the magnets 80, 80 is 50 to 150 mm (for example, 100 mm) so as to avoid interference between the magnets 80, 80 and the holder unit 22.

By virtue of the configuration of the holder unit 22 as described above, when a slave disk 40 is loaded or removed, the stationary holder 23 and the movable holder 24 are positioned so as to be a predetermine distance apart from each other as shown in FIG. 10. Therefore, handling of the slave disk 40 by a disk supply unit 26 and a disk carryout unit 34 (described later) is facilitated.

In the main body 12 shown in FIG. 8, the index table 50 is intermittently rotated by a drive motor (not shown) whereby each holder unit 22 is successively conveyed to and stopped at positions, which are associated with respective indexed positions, where subsequent processing positions are carried out. In this way, plural kinds of work can be performed in parallel. The index table 50 is intermittently driven such that the four holder units 22 are certainly positioned at four predetermined position, respectively. In other words, each holder unit 22 is adapted to stop after each rotation through 90 degrees.

Further, the main body 12 shown in FIG. 8 comprises a disk supply unit 26 provided on one side (left side as viewed from the front of FIG. 8) of the top surface of the base 60 and a disk carryout unit 34 provided on the other side (right side as viewed from the front of FIG. 8) of the top surface of the base 60.

The disk supply unit 26 is a unit which can directly transport a slave disk 40 from the disk supply cassette 38 to the holder unit 22 to which the master disks 46, 46 are attached, without passing the slave disk 40 to any other chuck mechanism in the course of this step.

On the contrary, the disk carryout unit 34 is a unit which can directly transport the slave disk 40 after subjected to the magnetic transfer process to the disk carryout cassette 56, without passing the slave disk 40 to any other chuck mechanism in the course of this step.

The slave disk 40 removed from the disk supply cassette 38 is relatively positioned to the master disk 46, which has been attached to the stationary holder 23 of the holder unit 22, by the disk supply unit 26. Then, the slave disk 40 is passed to and attached by vacuum to the holder unit 22 via an aperture provided in the master disk 46, wherein the master disk 46 and the slave disk 40 are conjoined and held such that a magnetic information recorded surface the master disk 46 and a magnetic information recordable surface of the slave disk 40 are being in contact with each other. An attracting groove (not shown) for attracting a portion the slave disk 40 in the vicinity of the radially innermost portion of is provided within the stationary holder 23, and the slave disk 40 is held by suction adsorption by the attracting groove.

The disk supply unit 26 comprises: a chuck mechanism 42 constituted by two chucks 42a, 42b which are holders of a kind of chucking the radially innermost portion of the slave disk 40 as shown in FIG. 9; an X-axis robot 27, a Y-axis robot 28, and a Z-axis robot 29 as shown in FIG. 8; and a rotary cylinder 44, which has a rotary shaft extending in the X-axis direction, for rotating the chucks 42a, 42b such that the slave disk 40 is rotated 180 degrees in Y-Z plane.

In this way, the disk supply unit 26 is adapted to rotate 180 degrees the chucks 42a, 42b chucking the radially innermost portion of the slave disk 40 by means of the rotary cylinder 44, so that the orientations of the slave disk 40 and chucks 42a, 42b are inverted.

The disk carryout unit 34 is a unit which receives the slave disk 40 subjected to magnetic transfer after the holder unit 22 is opened, and directly transports the slave disk 40 to the disk carryout cassette 45 and places the slave disk 40 therein.

The disk carryout unit 34 comprises: a chuck mechanism 52 constituted by two chucks 52a, 52b which are holders of a kind of chucking the radially innermost portion of the slave disk 40; an X-axis robot 35, a Y-axis robot 36, and a Z-axis robot 37; and a rotary cylinder 54, which has a rotary shaft extending in the Y-axis direction, for rotating the chucks 52a, 52b such that the slave disk 40 is rotated 180 degrees in X-Z plane.

In this way, the disk carryout unit 34 is adapted to rotate 180 degrees the chucks 52a, 52b chucking the radially innermost portion of the slave disk 40 by means of the rotary cylinder 54, so that the orientations of the slave disk 40 and chuck mechanism 52 are inverted.

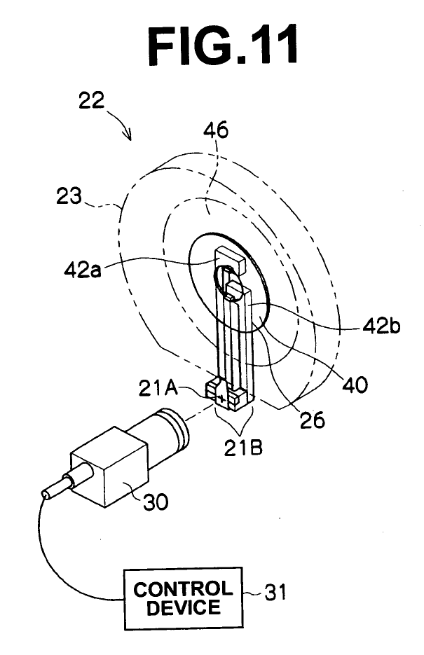

As shown in FIG. 11, a reference mark 21A is provided in advance on a bottom surface of the stationary holder 23 of the holder unit 22, and recognition marks 21B, 21B have been respectively provided in advance on the chucks 42a, 42b of the disk supply unit 26. The reference mark 21A and the recognition marks 21B, 21B are visually recognized by a recognition unit 30.

This recognition unit 30 is disposed on the base 60 at a position near the side which is remote from the position where the disk supply cassette 38 is provided. The recognition unit 30 visually recognizes the reference mark 21A and the recognition marks 21B, 21B, which have been respectively provided on the holder unit 22 and the disk supply unit, when positioning the slave disk 40, which is transported by the disk supply unit 26, with respect to the master disk 46.

A control device 30A as a positioning means is connected to the recognition unit 30. The control device 30A determine the center of the master disk 46 based on the recognized reference mark 21A, and determine the center of the slave disk 40 based on the recognized recognition marks 21B, 21B. Then, the control device 30A controls the Y-axis robot 28 and the Z-axis robot 29 of the disk supply unit 26 to move to align the center of the master disk 46 and the center of the slave disk 40 with each other.

The slave disk 40 positioned as described above is moved, by the X-axis robot 27 of the disk supply unit 26, to a position where the slave disk 40 abuts against the master disk 46 which has been held within the stationary holder 23, and then held by suction within the stationary holder 23.

In this case, the positional relationship between the reference mark 21A provided on the stationary holder 23 and the center position of the master disk 46 held within the stationary holder 23 has been taught to the control device 30A in advance.

On the other hand, the relationship between the recognition marks 21B, 21B and the center position of the slave disk 40 has been taught to the control device 30A in advance, assuming that the center of the slave disk 40 is located on the line extending between the portions upon which the chucks 42b, 42b are abutting as a result of the chucking operation of the chuck mechanism 42.

Based of the positional relationships which have been taught as mentioned above, the control device 30A can determine the positional relationship between the slave disk 40 and the master disk 46.

Hereinafter, the magnetic transfer device 32 which is a characterizing part of the invention will be described. The magnetic transfer devices 32, 32 are for applying a magnetic field of predetermined intensity for promoting the effect of the magnetic transfer to master disks 46, 46 and a slave disk 40.

More specifically, the magnetic transfer devices 32 and 32 are magnets spaced from each other and disposed one on each side of the holder unit 22, which holds therein master disks 46, 46 respectively locked to the stationary holder 23 and the movable holder 24 and a slave disk disposed between the master disks 46, 46, as viewed in the direction of stacking the master disks 46, 46 and the slave disk 40.

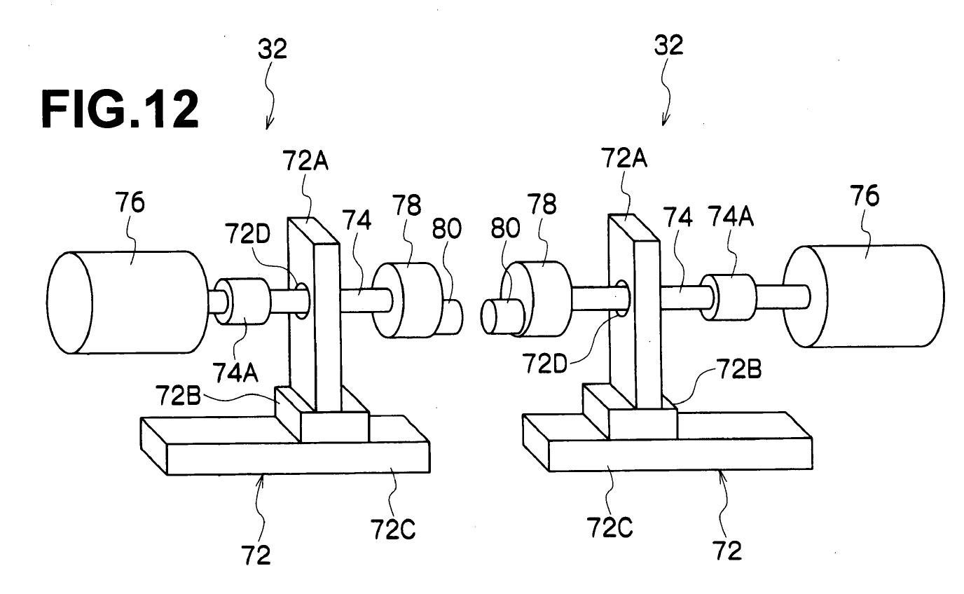

FIG. 12 is a perspective view showing a construction of the magnetic transfer devices 32, 32. Here, the holder unit 22 is not shown. The magnetic transfer device 32 is constituted by a rotary drive mechanism, a linear drive mechanism, and a magnetic field generating device (magnet).

The linear drive mechanism comprises a slide base 72 and a linear motor (not shown) disposed on the lower surface of the slide base 72. The slide base 72 is constituted by a stationary stage 72C and a movable stage 72B. A bearing stand 72A is disposed in a standing condition on the upper surface of the movable stage. As the slide base 72, any known linear guide mechanism (for example, LM-guide manufactured by THK kabushiki kaisha) may be used. As the linear motor, any of various known type may be used.

The rotary drive mechanism comprises a bearing 72D which fixedly fitted in the bearing stand 72A, a shaft 74 supported by the bearing 72D, a motor 76 connected to one end of the shaft 74 via a coupling 74A, and a magnet holder fixed to the other end of the shaft 74. The magnet holder 78 is a cylinder formed of a nonmagnetic material.

AS the motor 76, a motor is preferable which can easily match the phases of magnets 80, 80 described later, and can provide a uniform rotation speed and in turn provide a higher magnetic transfer accuracy. To match the phases of the magnets 80, 80 describer later, it is also preferable that a set of a detection mark by which the rotary position of the magnetic holder 78 can be detected and a mark detection device is provided on the magnet holder 78, and that a rotary encoder is provided on the magnet holder 78.

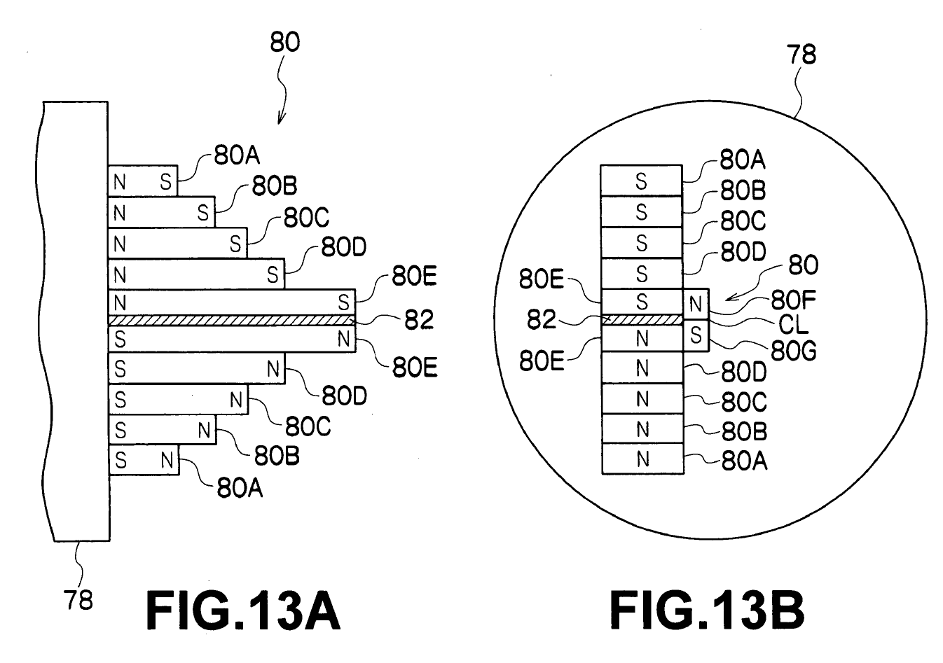

The magnetic field generating device may be a magnet 80 that is fixed to the distal end of the magnetic holder 78. FIG. 13A is a front view and FIG. 13B is a side view, showing a structure of the magnet 80. As shown in these figure, the magnet 80 is constituted by a plurality of bar-like magnets 80A, 80B, 80C, 80D and 80E which are substantially same in width but different in length, and a nonmagnetic substance 82 is disposed between the center bar-like magnets 80E, 80E.

These bar-like magnets 80A, 80B, 80C, 80D and 80E are oriented such that those located on one side of the nonmagnetic substance 82 and those located on the other side of the nonmagnetic substance 82 have the polarity opposite to each other. Further, as shown in FIG. 13B, the magnet 80 is positioned so as to be offset from the rotation axis CL of the magnet holder 78. Further, bar-like magnets 80F, 80G are respectively disposed on the end surface side of the bar-like magnets 80E, 80E.

With the magnetic transfer devices 32, 32, magnetic patterns (transfer data) born on master disks 46, 46 can be transferred to a slave disk 40 in the following manner: when a rotary drive mechanism gives a relative rotation movement between the holder 22 and a pair of the magnets 80, 80 each disposed at a predetermined distance from a back side surface of each of the pair of master mediums, the linear drive mechanism increases or decreases the predetermined distance, and the pair of magnets 80, 80 apply magnetic fields in the circumferential direction of the slave disk 40 and the pair of the master disks.

Hereinafter, an operational method of the magnetic transfer apparatus as described above will be described.

As the operation started, slave disks 40 within the disk supply cassette 38 are successively chucked and taken out on one-by-one basis by the chuck mechanism 42 (chucks 42a, 42b) of the disk supply unit 26.

After the slave disk 40 taken out of the cassette is inverted in Y-Z plane by rotation of the rotary cylinder 44, the slave disk 40 is moved by the X-axis robot 27, in the direction normal to the opening-closing direction of the holder unit 22, to a position adjacent to a gap between the master disks 46, 46 defined by the opened holder unit 22 positioned at a disk supply step position 16, and placed between the gap between the master disks 46, 46 by the Y-axis robot 28.

At this time, the respective master disks 46, 46 have been locked within the stationary holder 23 and the movable holder 24 such that the center of the holder unit 22 and the canters of the master disks 46 are accurately aligned with each other using vacuum adsorption, adhesion or the like by off-line setup.

Meanwhile, the slave disk 40 supplied between the stationary holder 23 and the movable holder 24 of the holder unit 22 is moved by the X, Y, and Z-axis robots of the disk supply unit 26 to a recognition position where the center of the slave disk 40 is substantially aligned with the center of the master disk locked within the stationary holder 23 and the clearance between the slave disk 40 and each master disk 46 is about 0.5 mm.

Then, the reference mark 21A which has been provided on the bottom the stationary holder 23, and the recognition marks 21B, 21B which have been respectively provided on the chuck mechanism 42 (chucks 42a, 42b) of the disk supply unit 26 are recognized by the recognition unit 30.

Based on the recognition result, the slave disk 40 is positioned by the Y-axis robot 28 and the Z-axis robot 29 of the disk supply unit 26 such that the center of the master disk 46 determined using the reference mark 21A and the center of the slave disk 40 determined using the recognition marks 21B, 21B of the chuck mechanism 42 are aligned to each other.

Then, the slave disk 40 is moved, by the X-axis robot 27, to a position where the slave disk 40 abuts against the master disk 46 which has been held within the stationary holder 23, and then held by suction within the stationary holder 23.

After that, the movable holder 24 is moved towards the stationary holder 23 by the robot arm 70 so that the opposite sides of the slave disk 40 are respectively conjoined with the two master disks 46, 46 with the slave disk 40 and the two master disks being arranged in a sandwiched manner. In this way, the slave disk 40 and the two master disks 46, and 46 are held in a conjoined manner with the opposite sides of the slave disk being respectively abutting against the two master disks.

Then, the index table 50 is rotated 90 degrees and the holder unit 22 is positioned to a position 18 where the following step which is the magnetic transfer step is carried out. Then the magnetic transfer devices 32, 32 are respectively moved towards the opposite side surfaces of the holder unit 22 from opposite sides and apply magnetic fields from opposite sides to the holder unit 22 while rotating the magnets 80, 80. As a result, the magnetic patter of each master disk 46 is magnetically transferred to each side of the slave disk 40.

Hereinafter, the aforementioned magnetic transfer will be described in detail. First, one embodiment in which, when magnetic transfer is performed, a magnetic field is applied to a target slave medium while rotating the magnet and moving the rotating magnet towards the holder unit 22 will be described.

Before starting the transfer preparation step, the distance between the distal ends of the magnets 80, 80 is set 50 to 150 mm (for example, 100 mm) and accordingly interference between the magnets 80, 80 and the holder unit 22 is prevented. Further, as shown in FIG. 8, the rotation axis of the magnet 80 (magnet holder 78) and the center axis of the slave disk 40 and master disks 46, 46 held within the holder unit 22 are not aligned with each other.

From the sate, the magnetic field applying devices 32, 32 are moved in the X-axis direction by a linear guide 100 shown in FIG. 8 (and a drive mechanism not shown) such that the rotation axis of the magnet 80 (magnet holder 78) and the center axis of the slave disk 40 and master disks 46, 46 held within the holder unit 22 are aligned with each other. It is preferable that the amount of displacement between the axes should preferably be suppressed within ±0.05 mm.

In this state, the distance between the distal ends of the magnets 80, 80 is 100 mm. When the thickness of the slave disk 40 is 1 mm, the distance between the recordable surface of the slave disk and the distal end of the corresponding magnet 80 is 49.5 mm.

Then the linear motors of the magnetic field transfer devices 32, 32 are driven to move the movable stage 72B of the slide base 72 in the Y-axis direction such that the distal end of the magnet 80 is brought closer to the back side of the magnetic disk 46 to a position at a distance 3 to 15 mm (for example, 7 mm) from the back side. This movement is performed at relatively high speed (for about 0.5 seconds).

The distance, which does not affect the quality of magnetic transfer, of the magnet 80 to the back side of the master disk varies depending on the intensity of the magnetic field that the magnet 80 has, a size of the magnet 80 and the like. In the particular embodiment, a typical permanent magnet is used. In this case, when the magnet 80 is 3 to 15 mm apart from the back side of the master disk, the magnet would no longer affect the magnetic transfer quality. Meanwhile, when the magnet is brought excessively closer to the master disk, problems associated with transfer quality do not occur. However, in the following magnetic transfer step, operation speed is significantly reduced, as a result of which, there arises the problem that the cycle time required for magnetic transfer increases.

During this movement of the magnets 80, the phases of the magnets 80, 80 may be matched or not matched, and the magnets 80, 80 may be rotated or not rotated, since the magnetic transfer quality is not affected thereby. Further, the distance between the distal end of one magnet 80 and the recordable surface of the target slave disk and the distance between the distal end of the other magnet 80 and the recordable surface of the target slave disk may be equal or not equal to each other. Therefore, controlling the magnets is easy and the magnets can be moved at relatively high speed.

After movement of the magnets 80, 80, it is preferable that the phases of the magnets 80, 80 are kept matched. Specifically, it is preferable that the phase difference (angular difference) between the magnets 80, 80 are kept within ±0.1 degree, and the amount of the phase difference is kept 0.1 mm or less. This is because when the phase difference (angular difference) between the magnets is large, the magnetic field intensities that the slave disk 40 and the master disks 46, 46 would undergo during the magnetic transfer step become unbalanced between the opposite sides thereof and therefore good magnetic transfer is not ensured.

Then, control goes to the magnetic transfer step. In this step, while rotating the magnets 80, 80, the linear motors are driven such that the distance T is reduced and the top portion (movable stage 72B) of the slide base 72 is moved. Magnetic fields are applied in the circumferential direction of the slave disk 40 and master disks 46, 46 by the magnets 80, 80, whereby the magnetic patterns borne on the master disks 46, 46 are transferred to the slave disk.

While there is no restriction upon the traveling speed and rotation speed of the magnets 80, 80, these magnets are driven with high accuracy at a relatively low rotation speed and a relatively low traveling speed, with a view to drive the magnets while controlling to avoid phase difference or distance difference therebetween, and with a view to ensure a sufficient magnetic transfer quality.

Specifically, for example, the magnets are moved a distance of 5 mm in 0.5 to 3 seconds. While there is no restriction upon the revolutions per minute of the magnet 80 (magnet holder 78), the magnet should be driven at a speed preferably in the range of 30 to 600 rpm, and more preferable in the range of 60 to 240 rpm. For example, when the traveling speed of the magnet 80 is 5 mm/s and the revolutions-per-minute of the magnet 80 is 120 rpm (2 ps), the magnet 80 is rotated two turns.

When the distance T between the back side of each master disk 46 and the distal end of each magnet 80 becomes a predetermined value within a range of 0.5 to 5 mm (for example, 2 mm), the linear motor is stopped. In this time, with a view to ensure a sufficient transfer quality, the magnet 80 is further rotated at least one turn with the linear motor being stopped. The rotation speed in this case may be 60 to 240 rpm which is the same speed when the magnet is forwarded, or may be as low as 10 rpm for further reducing the phase difference.

Then, the distance T between the back side of each master disk 46 and the distal end of each magnet 80 is increased to become larger than the predetermined value within a range of 0.5 to 5 mm (for example, 2 mm) so that they are separated at distance within a range of 3 to 15 mm (for example, 7 mm). In this case, it is also preferable that the phase difference (angular difference) between the magnets 80, 80 are kept within ±0.1 degree, and the amount of the phase difference is kept 0.1 mm or less. Thus, the magnetic transfer step completes.

After that, the magnets 80, 80 are returned to their home positions (for example, the positions where the distance between the distal ends of the magnets is 100 mm) at high speed.

Then, another embodiment in which, when magnetic transfer is performed, a magnetic field is applied to a target slave medium while rotating the magnet and moving the rotating magnet away from the holder unit 22 will be described. This embodiment can be implemented in reverse order of the aforementioned procedure. Hereinafter, a brief description of this embodiment will be given.

In the transfer preparation step, when the magnetic transfer devices 32, 32 are respectively moved towards the opposite side surfaces of the holder unit 22 from opposite sides, the distance T between the back side of each master disk 46 and the distal end of each magnet 80 should preferably be set within a range of 0.5 to 5 mm (for example, 2 mm). This is because, if the distance T is less than 0.5 mm, the magnets 80, 80 abut against the master disks 46, 46, which may causes a malfunction.

In this case, it is also preferable that the phases of the magnets 80, 80 are kept matched. Specifically, it is preferable that the phase difference (angular difference) between the magnets 80, 80 are kept within ±0.1 degree, and the amount of the phase difference is kept 0.1 mm or less. This is because when the phase difference (the angular difference or the amount of difference) between the magnets is large, the magnetic field intensities that the slave disk 40 and the master disks 46, 46 would undergo during the magnetic transfer step become unbalanced between the opposite sides thereof and therefore good magnetic transfer is not ensured.

Then, in the magnetic transfer step, while rotating the magnets 80, 80, the linear motors are driven such that the distance T is increased and the top portion (movable stage 72B) of the slide base 72 is moved. Magnetic fields are applied in the circumferential direction of the slave disk 40 and master disks 46, 46 by the magnets 80, 80, whereby the magnetic patterns borne on the master disks 46, 46 are transferred to the slave disk.

In this case, while there is no restriction upon the revolutions per minute of the magnet 80 (magnet holder 78), the magnet should be driven at a speed preferably in the range of 30 to 600 rpm, and more preferable in the range of 60 to 240 rpm.

When the distance T between the back side of each master disk 46 and the distal end of each magnet 80 becomes a value within a predetermined range of 3 to 15 mm (for example, 7 mm), the linear motor is stopped, and thus the magnetic transfer is completed.

After performing the magnetic transfer, the magnetic transfer devices 32, 32 are retracted to their initial position, the index table 50 is rotated 90 degrees and the holder unit 22 is positioned to a position 20 where the following step which is the disk carryout step.

Then, the movable holder 24 is moved away from the stationary holder 23. At this time, the slave disk 40 which has been subjected to magnetic transfer is held by suction within the stationary holder 23 in the same manner when it was supplied.

Then chuck mechanism 52 of the disk carryout unit 34 is penetrated between the stationary holder 23 and the movable holder 24 for chucking the radially innermost portion of the slave disk 40. Then, the slave disk 40 is removed from the master disk 46 held by the stationary holder 23 by releasing the vacuum attraction applied to the slave disk 40 by the stationary holder 23, and moving the chuck mechanism 52 of the disk carryout unit 34 by the X-axis robot 35 of the disk carryout unit 34.

Then, the slave disk 40 is retracted in the Y-axis direction through the clearance of the opened holder unit 22 by Y-axis robot 36 with the slave disk 40 being chucked by the chuck mechanism 52 of the disk carryout unit 34. After that, the slave disk 40 is rotated 180 degrees within Y-Z plane following the arc extending in the exterior of the apparatus, and the orientation thereof is vertically inverted together with the chuck mechanism.

Then, the slave disk 40 and the chuck mechanism 52 are moved to a position above the disk carryout cassette 56 by the X-, Y-, and Z-axis robots of the disk carryout unit 34, and the slave disk 40 is successively placed into the disk carryout cassette 56 on one-by-one basis.

The series of operations described above can be executed such that plural kinds of work can be performed in parallel by sequentially positioning the holder unit 22 to each individual process step position by intermittently rotating the index table 50.

Hereinafter, a transfer apparatus and method according to still another embodiment of the invention will be described. These particular embodiments are similar to the embodiments which have been described above except the structure of the magnetic transfer device 32. Therefore, no further description will be given here on the remaining components.

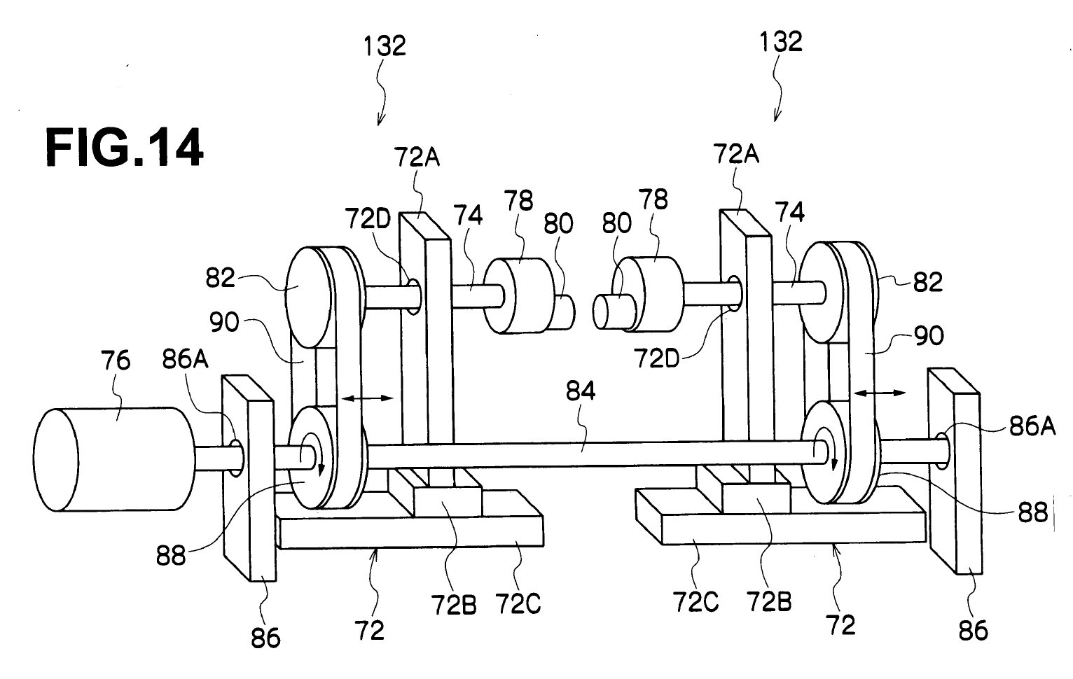

FIG. 14 is a perspective view showing a construction of the magnetic transfer devices 132, 132. Here, the holder unit 22 is not shown. In addition, similar reference numerals are used to denote identical or similar components as those of the magnetic transfer devices 32, 32 shown in FIG. 12, and further description thereon is not given. As in the magnetic transfer device 32 shown in FIG. 12, the magnetic transfer device 132 is constituted by a rotary drive mechanism, a linear drive mechanism, and a magnetic field generating member.

The rotary drive mechanism comprises a bearing 72D which fixedly fitted in the bearing stand 72A, a shaft 74 supported by the bearing 72D, a pulley 82 fixed to one end of the shaft 72, a magnet holder 78 fixed to the other end of the shaft, a drive shaft 84 provided parallel to the shaft 74, a motor 76 connected to one end of the drive shaft 84, bearing stands 86, 86 (including bearings 86A, 86A) for supporting the drive shaft 84 in the vicinity of its ends, driving pulleys 88, 88 which are loosely fitted with the drive shaft 84 in a slidable manner, and a timing belts 90, 90 for transferring a turning effort from the driving pulley 88 to the pulley 82.

Further, the driving pulleys 88, 88 which are loosely fitted with the drive shaft 84 in a slidable manner is constrained to the rotation of the drive shaft and not constrained in the axial direction of the drive shaft 84. In this way, when the pulley 82 is axially moved by the linear drive mechanism, an axial driving force is transferred to the driving pulley 88 via the timing belt 90, as a result of which, the driving pulley 88 is axially moved.

Since the magnets 80, 80 are rotated by a common rotary drive mechanism, any phase difference is not caused between the magnets 80, 80 during rotation.

With the magnetic transfer devices 32, 32 as described above, magnetic patterns born on master disks 46, 46 can be transferred to a slave disk 40 in the following manner: when a rotary drive mechanism gives a relative rotation movement between the holder 22 and a pair of the magnets 80, 80 each disposed at a predetermined distance from a back side surface of each of the pair of master mediums, the linear drive mechanism increases or decreases the predetermined distance, and the pair of magnets 80, 80 apply magnetic fields in the circumferential direction of the slave disk 40 and the pair of the master disks.

The magnetic transfer apparatus of the configuration described above is operated in the substantially same manner as the first embodiment described above, and it is therefore not described in any more detail below.

Hereinafter, a transfer apparatus and method according to another embodiment of the invention will be described. These particular embodiments are similar to the embodiments which have been described above except the structure of the magnetic transfer device 32 (132). Therefore, no further description will be given here on the remaining components.

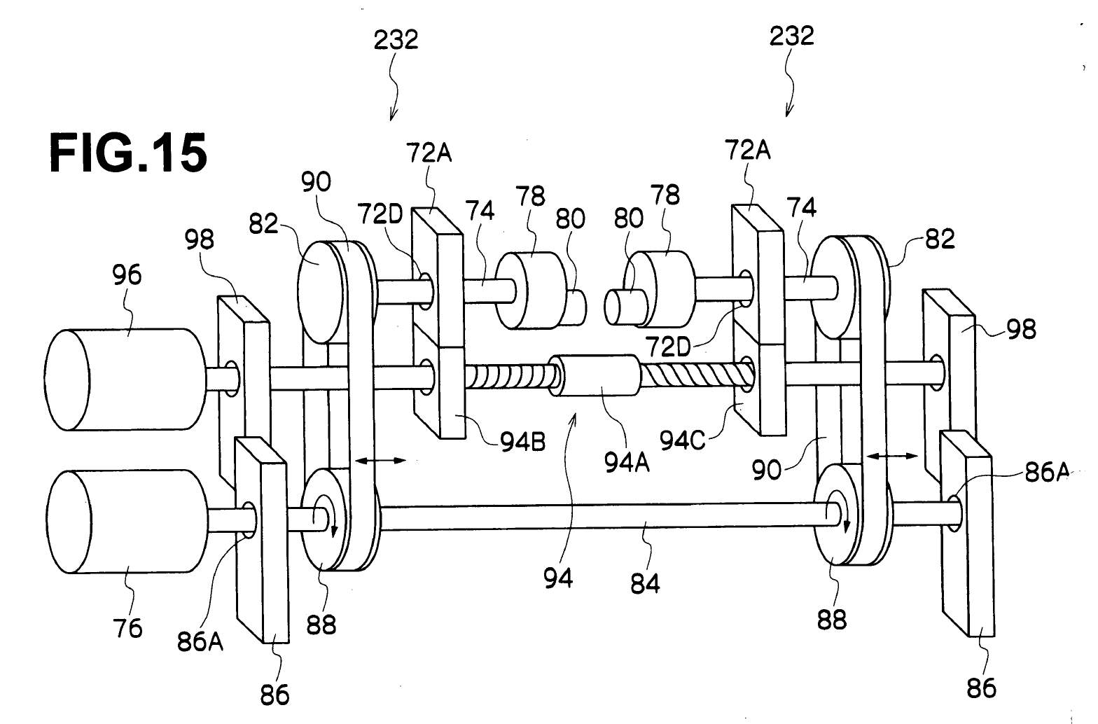

FIG. 15 is a perspective view showing a construction of the magnetic transfer devices 232, 232. Here, the holder unit 22 is not shown. In addition, similar reference numerals are used to denote identical or similar components as those of the magnetic transfer devices 132, 132 shown in FIG. 14, and further description thereon is not given. As in the magnetic transfer device 32 shown in FIG. 12 and the magnetic transfer device 132 shown in FIG. 14, the magnetic transfer device 232 is constituted by a rotary drive mechanism, a linear drive mechanism, and a magnetic field generating member.

The linear drive mechanism comprises a ball screw 94 for axial driving the bearing stands 72A, 72A and a motor 96 for turning the ball screw 94. In contrast to the aforementioned first and second embodiments, this bearing stand 72A is not integrally incorporated in the slide base 72 but a separate component.

The ball screw 94 is constituted by a ball screw element 94A which is a male screw thread and ball nuts 94B and 94C which are a female screw thread. The ball screw 94A is constituted by a central non-threaded portion, a normal threaded portion formed adjacent to the central portion on one side thereof, and a reverse threaded portion formed adjacent to the central portion on the other side thereof. The pitch of the normal thread and the pitch of the reverse thread are formed to have the same dimensions. The ball nuts 94B, 94C to be meshed therewith are formed to accommodate them.

The ball nuts 94B and 94C are attached to the lower end of the bearing stands 72A, 72A. Further, the ball screw 94A is rotatably supported by the bearing stand 98 which supports the non-threaded portion thereof. The motor 96 is connected to one end of the ball screw 94A, and the ball screw 94A is turned by motor 96.

By virtue of such structure of the ball screw 94, a pair of the magnets 80, 80 can be moved towards or away from the holder unit 22 at the same speed when the ball screw 94A is rotated by the motor 96. Accordingly, even during the magnetic transfer is performed, the distance between one holder unit 22 and the corresponding magnet 80 and the distance between the other holder unit 22 and the corresponding magnet 80 can be matched only by performing a proper initial position setting upon the holder unit 22 and the magnets 80, 80.

Similar to the second embodiment, since the magnets 80, 80 are rotated by a common rotary drive mechanism, any phase difference is not caused between the magnets 80, 80 during rotation.

With the magnetic transfer devices 232, 232 as described above, magnetic patterns born on master disks 46, 46 can be transferred to a slave disk 40 in the following manner: when a rotary drive mechanism gives a relative rotation movement between the holder 22 and a pair of the magnets 80, 80 each disposed at a predetermined distance from a back side surface of each of the pair of master mediums, the linear drive mechanism increases or decreases the predetermined distance, and the pair of magnets 80, 80 apply magnetic fields in the circumferential direction of the slave disk 40 and the pair of the master disks.

The magnetic transfer apparatus of the configuration described above is operated in the substantially same manner as the second embodiment described above, and it is therefore not described in any more detail below.

Although the magnetic transfer apparatus and method according to the embodiments of the present invention have been described in the foregoing, it should be understood that various modifications can be made without departing from the spirit and scope of the invention.

For example, distance T, described in connection with the embodiments of the invention, between the rear surface of the master disk 46 and the end surface of the magnet 80 is a value determined taking as an example the case of a slave disk 40 having a nominal outer diameter of 21.6 mm (0.85 inches). When the slave disk 40 larger than this (for example, a slave disk of the nominal outer diameter of 3.5 inch) or smaller than this is used, the optimum value varies depending thereon. Further, when an electro magnetic disk is used as the magnet 80 in lieu of a permanent magnet, the optimum value varies depending on its magnetic flux intensity.

Further, in any of the foregoing embodiments, the conjoined body of the master disks 46, 46 and the slave disk 40 is fixedly locked and the magnets 80, 80 are rotated. On the contrary, however, it is also possible that the magnets 80, 80 are fixedly locked and the conjoined body is rotated. Adopting such a configuration produces an advantage that d an effect that it is merely necessary to match the phases of the magnets 80 and 80 by an initial setting.

Further, any type of magnets other than those employed in the foregoing embodiments can be employed as the magnet 80. For example, instead of the permanent magnets as used in the present embodiment, electromagnets can be employed.

Further, the magnetic transfer apparatus 10 of the invention is not limited to employing the rotary indexing type structure of the embodiment described above, but can employ any structure such as of an in-line indexing type may be employed.

What is claimed is:

1. A magnetic transfer method for performing magnetic transfer, comprising the steps of: by a holder, conjoining in surface-to-surface contact a transfer master medium, on which transfer data is borne, and a slave medium, to which the transfer data is transferred, to form a conjoined body, and holding the conjoined body; and by a magnet disposed facing to a recordable surface of the slave medium, applying a transfer magnetic field to the transfer master medium held in the holder,
wherein the holder and the magnet are held movable relative to each other in a direction of a normal to a recordable surface of the slave medium; and
wherein a distance between the holder and the magnet as seen in the direction of the normal is adjusted when magnetic transfer is performed.

2. The magnetic transfer method as defined in claim 1, wherein the adjustment is performed such that a distance between the holder and the magnet as seen in the direction of the normal is made shorter when a size of a non-recordable region of the slave medium located at a central portion thereof is smaller.

3. The magnetic transfer method as defined in claim 1, wherein according to a distance between the holder and the magnet as seen in the direction of the normal, intensity of the transfer magnetic field is adjusted when magnetic transfer is performed.

4. The magnetic transfer method as defined in claim 1,
wherein the holder and the magnet are held movable relative to each other in a radial direction of the slave medium; and
wherein a position of the magnet with respect to the holder as seen in the radial direction is adjusted when magnetic transfer is performed.

5. The magnetic transfer method as defined in claim 4, wherein the adjustment is performed such that the magnet is positioned closer to a center of the holder when a size of a non-recordable region of the slave medium located at a central portion thereof is smaller.

6. The magnetic transfer method as defined in claim 1,
wherein the magnet has an N-pole portion and an S-pole portion for producing the transfer magnetic field, the N-pole portion and the S-pole portion being situated close to each other, a spacing between the N-pole portion and the S-pole portion being adjustable; and
wherein the spacing between the N-pole portion and the S-pole portion is adjusted when magnetic transfer is performed.

7. The magnetic transfer method as defined in claim 6, wherein the adjustment is performed such that the spacing between the N-pole portion and the S-pole portion is made smaller when a distance between the holder and the magnet as seen in the direction of the normal is shorter.

8. The magnetic transfer method as defined in claim 1, wherein the magnet is fixed and the holder is rotatable.

9. A magnetic transfer method for performing magnetic transfer, comprising the steps of: by a holder, conjoining in surface-to-surface contact a transfer master medium, on which transfer data is borne, and a slave medium, to which the transfer data is transferred, to form a conjoined body, and holding the conjoined body; and by a magnet disposed facing to a recordable surface of the slave medium, applying a transfer magnetic field to the transfer master medium held in the holder,
wherein the holder and the magnet are held movable relative to each other in a radial direction of the slave medium; and
wherein a position of the magnet with respect to the holder as seen in the radial direction is adjusted when magnetic transfer is performed.

10. A magnetic transfer apparatus comprising: a holder for conjoining in surface-to-surface contact a transfer master medium, on which transfer data is borne, and a slave medium, to which the transfer data is transferred, to form a conjoined body, and holding the conjoined body; and a magnet, disposed facing to a recordable surface of the slave medium, for applying a transfer magnetic field to the transfer master medium held in the holder,
further comprising a normal-direction drive mechanism for holding the holder and the magnet so as to be movable relative to each other in a direction of a normal to a recordable surface of the slave medium such that a distance between the holder and the magnet as seen in the direction of the normal can be adjusted.

11. The magnetic transfer apparatus as defined in claim 10, further comprising normal-direction movement control means for controlling the normal-direction drive mechanism such that a distance between the holder and the magnet in the direction of the normal is made shorter when a size of a non-recordable region of the slave medium located at a central portion thereof is smaller.

12. The magnetic transfer apparatus as defined in claim 10, further comprising magnetic field intensity adjusting means which can adjust intensity of the transfer magnetic field according to a distance between the holder and the magnet as seen in the direction of the normal.

13. The magnetic transfer apparatus as defined in claim 10, further comprising a radial-direction drive mechanism for holding the holder and the magnet so as to be movable relative to each other in a radial direction of the slave medium, such that a position of the magnet with respect to the holder as seen in the radial direction can be adjusted.

14. The magnetic transfer apparatus as defined in claim 13, further comprising radial-direction movement control means for controlling the radial-direction drive mechanism such that the magnet is positioned closer to a center of the holder when a size of a non-recordable region of the slave medium located at a central portion thereof is smaller.

15. A magnetic transfer apparatus comprising: a holder in which a transfer master medium, on which transfer data is borne, and a slave medium, to which the transfer data is transferred, are conjoined and held in surface-to-surface contact; and a magnet, disposed facing to a recordable surface of the slave medium, for applying a transfer magnetic field to the transfer master medium held in the holder,
wherein the magnet has an N-pole portion and an S-pole portion for producing the transfer magnetic field, the N-pole portion and the S-pole portion are situated close to each other, and a spacing between the N-pole portion and the S-pole portion is adjustable.

16. The magnetic transfer method as defined in claim 1, further comprising the step of giving a relative rotation movement between a pair of the magnets and the conjoined body constituted by the slave medium and a pair of the transfer master mediums.

17. The magnetic transfer method as defined in claim 16, further comprising a transfer preparation step in which a pair of the magnets are disposed at initial positions located at a substantially equal distance, as seen in a direction of thickness of the transfer master medium, from a surface of each of a pair of the master mediums on a side opposite the slave medium.

18. The magnetic transfer method as defined in claim 16, wherein phases of the pair of magnets around the rotation axis are matched.

19. The magnetic transfer apparatus as defined in claim 10, further comprising rotary drive means for giving a relative rotation movement between the holder and a pair of the magnets, wherein each magnet is disposed at a predetermined distance from a surface of each of a pair of the master mediums on a side opposite the slave medium.

20. The magnetic transfer apparatus as defined in claim 19, wherein the pair of magnets are positioned so as to be offset from a rotation axis of the relative rotation movement.
